(19) United States
(12) Patent Application Publication
(10) Pub. No.: US 2026/0131977 A1
(43) Pub. Date: May 14, 2026

(54) A Conveyor System

(71) Applicant: TECHNOLOGICAL RESOURCES PTY. LIMITED, Melbourne (AU)

(72) Inventors: Jamie Webster, Perth (AU); Craig Coleman, Perth (AU)

(73) Assignee: TECHNOLOGICAL RESOURCES PTY. LIMITED, Melbourne (AU)

(21) Appl. No.: 19/119,648

(22) PCT Filed: Oct. 19, 2022
(86) PCT No.: PCT/AU2022/051257

§ 371 Date: Apr. 9, 2025

(51) Int. Cl. B65G 15/08; B65G 15/64; B65G 39/12

(52) U.S. Cl. CPC B65G 15/08; B65G 15/64; B65G 39/12; B65G 2812/02217

(57) ABSTRACT

A conveyor system supporting a conveyor belt in a trough shape through a transition portion in which an elevation of the conveyor belt changes, the transition portion comprising an upward change in elevation and a subsequent downward change in elevation.

### TECHNICAL FIELD

The invention relates to a conveyor system.

The invention relates particularly, although by no means exclusively, to a conveyor belt redirection system.

The invention relates, particularly although by no means exclusively, to a conveyor belt redirection system that is configured to redirect a conveyor belt of a conveyor system.

### BACKGROUND

Conveyor systems are used in the resources industry to transport material between different stages and/or different components of a production workflow. For example, in an iron ore production facility, it is typical to use one or more conveyor systems to transport ore to/from crushing equipment, transportation trains and equipment at a port facility. Such conveyor systems are critical to the production process and as a consequence, any downtime of a conveyor system can have a significant effect on the production capacity of a production facility, and therefore the production facility's operating efficiency and cost.

Conveyor systems can be subject to various constraints that, to some extent, influence the profile of the conveyor system and/or the conveyor belt circuit of the relevant conveyor system. For example, shuttle conveyor systems typically include a transition portion where the conveyor belt drops from a linear belt path (i.e. a belt path with no vertical curvature) at one elevation to another linear belt path at a lower elevation. This is because a part of the shuttle of the shuttle conveyor is retracted underneath upstream idlers when the shuttle is moved from an extended position to a retracted position. The idlers of the shuttle are required to be at a lower elevation than those upstream of the shuttle, so that they can be moved underneath the upstream idlers with retraction of the shuttle.

Often, conveyor systems include a conveyor belt that is shaped into a trough during operation. When a trough-shaped conveyor belt is directed through a change in elevation, for example, at a transition portion of a shuttle conveyor, the conveyor belt forms a convex curve and a concave curve. Maintaining a conveyor belt in a trough through the vertical curves of a change in elevation subjects the conveyor belt to stresses. The stresses can cause the conveyor belt to form relatively complex curved shapes as it transits the change in elevation. For example, the conveyor belt may form a dogleg shape (when viewed from the side) throughout at least part of the change in elevation.

In some cases, the radii of the vertical curves of the conveyor belt, at a change in elevation, can be significantly less than a recommended minimum operating radius of the conveyor belt, when shaped to form the trough. This can result in the conveyor belt being subject to overstressing at its edges, buckling and/or other non-recoverable bending, causing damage to the conveyor belt. This overstressing at the edges of the conveyor belt can be significantly above permissible belt stress limits, resulting in damage such as cracking of the conveyor belt at its edges. The damage caused by the stresses imparted on the conveyor belt can require the conveyor belt to be repaired or replaced at a higher frequency than a conveyor belt that is not subject to similar stresses.

The constraints of the conveyor system that influence the distance over which a change in elevation of the conveyor belt can occur may be difficult or impossible to adjust whilst maintaining a desired functionality of the conveyor system. For example, the conveyor system may be required to convey a material over a certain distance, through a path that is restricted as a result of one or more constraints such as the material properties of the conveyor belt, positioning and sizing of idlers and movement requirements of certain system components such as a shuttle of a shuttle conveyor system.

Therefore, providing a conveyor system that reduces conveyor belt damage whilst still fulfilling the relevant operational requirements (i.e. conveying a material by directing a trough-shaped conveyor belt through a change in elevation) can provide significant improvements to the operating efficiency and production cost of a production facility.

The problem of overstressing a conveyor belt that is shaped into a trough through an elevation change is a longstanding issue in the conveyor industry. It may be at least somewhat addressed by one or more of reducing the trough angles of the conveyor belt at the change in elevation and increasing the rating of the conveyor belt. However, reducing the trough angles can result in increased material spillage and higher rated conveyor belts are typically heavier (requiring more energy to be used to drive the conveyor system) and more expensive to manufacture, procure and/or install.

It is to be understood that, if any prior art publication is referred to herein, such reference does not constitute an admission that the publication forms a part of the common general knowledge in the art, in Australia or any other country.

### SUMMARY OF THE DISCLOSURE

There is provided a conveyor system supporting a conveyor belt in a trough shape through a transition portion in which an elevation of the conveyor belt changes.

The transition portion may comprise an upward change in elevation and a subsequent downward change in elevation.

The downward change in elevation may be greater than the upward change in elevation.

The upward change in elevation may be greater than the downward change in elevation.

The conveyor belt may be directed through a number of vertical curves at the transition portion.

A radius of curvature of one or more of the vertical curves may be greater than a threshold radius.

The conveyor belt may be directed through a first concave up vertical curve and a first concave down vertical curve at the upward change in elevation.

The conveyor belt may be directed through a second concave down vertical curve at the downward change in elevation.

The conveyor system may comprise: a plurality of trough idlers; and a support structure onto which the plurality of trough idlers are mounted.

The trough idlers may be configured to support the conveyor belt in the trough shape.

The plurality of trough idlers may comprise: a first plurality of intermediate trough idlers comprising a first subset of trough idlers that form a first concave up idler path; and a second subset of trough idlers that form a first concave down idler path.

The first concave up idler path may define a first radius of curvature that is greater than a first threshold radius.

The first concave down idler path may define a second radius of curvature that is greater than a second threshold radius.

The first concave up idler path and the first concave down idler path may form an ascending idler path that is contiguous.

The plurality of trough idlers may comprise: a second plurality of intermediate trough idlers; and an end trough idler.

The second plurality of intermediate trough idlers and the end trough idler may form a second concave down idler path.

A radius of curvature of the second concave down idler path may be greater than a third threshold radius.

The ascending idler path and the second concave down idler path may be contiguous.

The support structure may comprise: a standing idler support structure; and a hanging idler support structure.

The first plurality of intermediate trough idlers may comprise a number of standing idlers that are mounted to the standing idler support structure.

The second plurality of intermediate trough idlers may comprise a number of hanging idlers that are mounted to the hanging idler support structure.

The conveyor system may further comprise a shuttle. The shuttle may comprise: a plurality of shuttle idlers configured to support the conveyor belt; and a head pulley.

The shuttle may be configured to be moved between: an extended position; and a retracted position in which one or more of the shuttle idlers are retracted underneath the transition portion.

The conveyor system may further comprise a shuttle drive system that is operably connected to the shuttle, the shuttle drive system being operable to move the shuttle between the extended position and the retracted position.

Movement of the shuttle from the extended position to the retracted position may cause at least one of the plurality of shuttle trough idlers to pass below one of the second plurality of intermediate trough idlers.

There is provided a conveyor system supporting a conveyor belt in a trough shape through a transition portion in which an elevation of the conveyor belt changes.

The transition portion may comprise a downward change in elevation and a subsequent upward change in elevation.

The upward change in elevation may be greater than the downward change in elevation.

The conveyor belt may be directed through a number of vertical curves at the transition portion.

A radius of curvature of one or more of the vertical curves may be greater than a threshold radius.

There is provided a conveyor belt redirection system. The conveyor belt redirection system may comprise: a plurality of trough idlers supporting a conveyor belt; and a support structure supporting the plurality of trough idlers. The plurality of trough idlers may comprise: an initial trough idler supported at an initial elevation, relative to a reference plane; an end trough idler supported at an end elevation, relative to the reference plane; a first plurality of intermediate trough idlers supported along a first longitudinal length of the conveyor belt redirection system, each successive trough idler of the first plurality of intermediate trough idlers being supported at a higher elevation, relative to the reference plane, than a preceding trough idler of the first plurality of intermediate trough idlers; and a second plurality of intermediate trough idlers supported along a second longitudinal length of the conveyor belt redirection system that is between an end of the first longitudinal length and the end trough idler, each successive trough idler of the second plurality of intermediate trough idlers being supported at a lower elevation, relative to the reference plane, than a preceding trough idler of the second plurality of intermediate trough idlers.

There is provided a conveyor belt redirection system. The conveyor belt redirection system may comprise: a plurality of trough idlers configured to support a conveyor belt. The plurality of trough idlers may comprise: an initial trough idler; a first plurality of intermediate trough idlers; a second plurality of intermediate trough idlers; and an end trough idler. The plurality of trough idlers may comprise a support structure configured to support: the initial trough idler at an initial elevation, relative to a reference plane; the end trough idler at an end elevation, relative to the reference plane; the first plurality of intermediate trough idlers along a first longitudinal length of the conveyor belt redirection system at successively increasing elevations, relative to the reference plane, that are greater than the initial elevation; and a second plurality of intermediate trough idlers along a second longitudinal length of the conveyor belt redirection system that is between an end of the first longitudinal length and the end trough idler, at successively decreasing elevations, relative to the reference plane, that are greater than the end elevation.

The first plurality of intermediate trough idlers may comprise a first subset of trough idlers that form a first concave up idler path.

The first concave up idler path may define a first radius of curvature that is greater than a first threshold radius.

The first plurality of intermediate trough idlers may comprise a second subset of trough idlers that form a first concave down idler path.

The first concave down idler path may define a second radius of curvature that is greater than a second threshold radius.

The first concave up idler path and the first concave down idler path may form an ascending idler path that is contiguous.

The ascending idler path may extend from a first elevation, relative to the reference plane, that is equal to or greater than the initial elevation, to a peak elevation, relative to the reference plane, that is greater than the initial elevation.

The second plurality of intermediate trough idlers and the end trough idler may form a second concave down idler path.

A radius of curvature of the second concave down idler path may be greater than a third threshold radius.

The third threshold radius may be equal to the second threshold radius.

The second concave down idler path may extend from a second peak elevation, relative to the reference plane, to a descended elevation, relative to the reference plane, that is less than the second peak elevation.

The peak elevation and the second peak elevation may be equal.

The ascending idler path and the second concave down idler path may be contiguous.

The plurality of trough idlers may comprise: a third plurality of intermediate trough idlers supported along an intermediate longitudinal length of the conveyor belt redirection system that is between the end of the first longitudinal length and an end of the second longitudinal length.

One or more trough idlers of the third plurality of intermediate trough idlers may be supported, by the support structure, at a higher elevation, relative to the reference plane, than a preceding trough idler of the third plurality of intermediate trough idlers.

One or more trough idlers of the third plurality of intermediate trough idlers may be supported, by the support structure, at a common elevation, relative to the reference plane, as a preceding trough idler of the third plurality of intermediate trough idlers.

One or more trough idlers of the third plurality of intermediate trough idlers may be supported, by the support structure, at a lower elevation, relative to the reference plane, than a preceding trough idler of the third plurality of intermediate trough idlers.

The plurality of trough idlers may comprise a third plurality of intermediate trough idlers.

The support structure may be configured to support one or more trough idler of the third plurality of intermediate trough idlers along an intermediate longitudinal length of the conveyor belt redirection system that is between the end of the first longitudinal length and an end of the second longitudinal length, at a higher elevation, relative to the reference plane, than a preceding trough idler of the third plurality of intermediate trough idlers.

The support structure may be configured to support one or more trough idler of the third plurality of intermediate trough idlers along an intermediate longitudinal length of the conveyor belt redirection system that is between the end of the first longitudinal length and an end of the second longitudinal length, at a common elevation, relative to the reference plane, as a preceding trough idler of the third plurality of intermediate trough idlers.

The support structure may be configured to support one or more trough idler of the third plurality of intermediate trough idlers along an intermediate longitudinal length of the conveyor belt redirection system that is between the end of the first longitudinal length and an end of the second longitudinal length, at a lower elevation, relative to the reference plane, than a preceding trough idler of the third plurality of intermediate trough idlers.

The first plurality of intermediate trough idlers may comprise a number of standing idlers that are configured to be mounted to a standing idler support structure.

The second plurality of intermediate trough idlers may comprise a number of hanging idlers that are configured to be mounted to a hanging idler support structure.

The plurality of trough idlers may be configured to support the conveyor belt such that the conveyor belt forms a trough for holding a material; a concave up portion that is supported at least in part by some of the first plurality of intermediate trough idlers; and a concave down portion that extends from an end of the first concave up portion; and is supported by a number of the first plurality of intermediate trough idlers and a number of the second plurality of intermediate trough idlers.

The conveyor belt redirection system may further comprise a shuttle. The shuttle may comprise: a shuttle body; a plurality of shuttle trough idlers mounted to the shuttle body; and a head pulley mounted to the shuttle body.

The shuttle may be configured to be moved between: an extended position; and a retracted position where the head pulley is closer to the initial trough idler than when the shuttle is in the extended position.

In each of the extended position and the retracted position, one or more of the plurality of shuttle trough idlers may be at an elevation, relative to the reference plane, that is less than that of each of the second plurality of trough idlers.

Movement of the shuttle from the extended position to the retracted position may cause at least one of the plurality of shuttle trough idlers to pass below one of the second plurality of intermediate trough idlers.

The conveyor belt redirection system may further comprise a shuttle drive system that is configured to be connected to the shuttle. The shuttle drive system may be operable to move the shuttle between the extended position and the retracted position.

The support structure may comprise: an initial trough idler mounting portion, the initial trough idler being mountable to the initial trough idler mounting portion; an end trough idler mounting portion, the end trough idler being mountable to the end trough idler mounting portion; a first plurality of intermediate trough idler mounting portions that are positioned along the first longitudinal length of the conveyor belt redirection system at successively increasing elevations, relative to the reference plane, each of the first plurality of intermediate trough idlers being mountable to a respective one of the first plurality of intermediate trough idler mounting portions; and a second plurality of intermediate trough idler mounting portions that are positioned along the second longitudinal length of the conveyor belt redirection system at successively decreasing elevations, relative to the reference plane, each of the second plurality of intermediate trough idlers being mountable to a respective one of the second plurality of intermediate trough idler mounting portions.

There is provided a support structure. The support structure may comprise: an initial trough idler mounting portion configured to enable an initial trough idler to be mounted at an initial elevation, relative to a reference plane; an end trough idler mounting portion configured to enable an end trough idler to be mounted at an end elevation, relative to the reference plane; a first plurality of intermediate trough idler mounting portions positioned along a first longitudinal length of the support structure, the first plurality of intermediate trough idler mounting portions being configured to enable a first plurality of intermediate trough idlers to be positioned at successively increasing elevations, relative to the reference plane, that are greater than the initial elevation; and a second plurality of intermediate trough idler mounting portions positioned along a second longitudinal length of the support structure, the second plurality of intermediate trough idler mounting portions being configured to enable a second plurality of intermediate trough idlers to be positioned along the second longitudinal length of the support structure, between an end of the first longitudinal length and the end trough idler, at successively decreasing elevations, relative to the reference plane, that are greater than the end elevation.

When the support structure is constructed, the initial trough idler mounting portion may be positioned at an initial trough idler mounting portion elevation, relative to the reference plane.

When the support structure is constructed, the end trough idler mounting portion may be positioned at an end trough idler mounting portion elevation, relative to the reference plane.

When the support structure is constructed, the first plurality of intermediate trough idler mounting portions may be positioned at successively increasing elevations, relative to the reference plane, that are greater than the initial trough idler mounting portion elevation.

When the support structure is constructed, the second plurality of intermediate trough idler mounting portions may be positioned at successively decreasing elevations, relative to the reference plane, that are greater than the end trough idler mounting portion elevation.

When the support structure is constructed, a first subset of the first plurality of intermediate trough idler mounting portions may define a first concave up mounting portion path.

The first concave up mounting portion path may have a first radius of curvature that is greater than a first threshold radius.

When the support structure is constructed, a second subset of the first plurality of intermediate trough idler mounting portions may define a first concave down mounting portion path.

The first concave down mounting portion path may define a second radius of curvature that is greater than a second threshold radius.

The first concave up mounting portion path and the first concave down mounting portion path may form an ascending mounting portion path.

The ascending mounting portion path may extend from a first mounting portion elevation, relative to the reference plane, that is equal to or greater than the initial elevation, to a peak mounting portion elevation, relative to the reference plane, that is greater than the initial elevation.

When the support structure is constructed, the second plurality of intermediate trough idler mounting portions may form a second concave down mounting portion path.

The second concave down mounting portion path may define a third radius of curvature that is greater than a third threshold radius.

The third threshold radius may be equal to the second threshold radius.

The second concave down mounting portion path may extend from a second peak mounting portion elevation, relative to the reference plane, to a descended mounting portion elevation, relative to the reference plane, that is less than the second peak mounting portion elevation.

The peak mounting portion elevation and the second peak mounting portion elevation may be equal.

The first concave down mounting portion path and the second concave down mounting portion path may be contiguous.

The support structure may further comprise: a third plurality of intermediate trough idler mounting portions positioned along an intermediate longitudinal length of the support structure that is between the end of the first longitudinal length and an end of the second longitudinal length.

The third plurality of intermediate trough idler mounting portions may be configured to enable one or more of a third plurality of intermediate trough idlers to be supported at a higher elevation, relative to the reference plane, than a preceding trough idler of the third plurality of intermediate trough idlers.

The third plurality of intermediate trough idler mounting portions may be configured to enable one or more of a third plurality of intermediate trough idlers to be supported at a common elevation, relative to the reference plane, as a preceding trough idler of the third plurality of intermediate trough idlers.

The third plurality of intermediate trough idler mounting portions may be configured to enable one or more of a third plurality of intermediate trough idlers to be supported at a lower elevation, relative to the reference plane, than a preceding trough idler of the third plurality of intermediate trough idlers.

The support structure may further comprise a shuttle supporting portion that is configured to support a shuttle: when the shuttle is in an extended position; when the shuttle is in a retracted position where a head pulley of the shuttle is closer to the initial trough idler mounting portion than when the shuttle is in the extended position; and as the shuttle is moved between the extended position and the retracted position.

There is provided a conveyor belt redirection system. The conveyor belt redirection system may comprise: the support structure described herein; and a plurality of trough idlers comprising: the initial trough idler; the end trough idler; the first plurality of intermediate trough idlers; and the second plurality of intermediate trough idlers.

The conveyor belt redirection system may further comprise the third plurality of intermediate trough idlers.

The support structure may further comprise a standing idler support structure.

The first plurality of trough idlers may comprise a number of standing idlers that are configured to be mounted to the standing idler support structure.

The support structure may further comprise a hanging idler support structure.

The second plurality of trough idlers may comprise a number of hanging idlers that are configured to be mounted to the hanging idler support structure.

The plurality of trough idlers may be configured to support a conveyor belt such that the conveyor belt forms: a trough for holding a material; a concave up portion that is supported at least in part by one or more of the first plurality of intermediate trough idlers; and a concave down portion that is supported by a number of the first plurality of intermediate trough idlers and a number of the second plurality of intermediate trough idlers.

There is provided a conveyor system. The conveyor system may comprise the conveyor belt redirection system described herein. The conveyor system may comprise the support structure described herein.

### BRIEF DESCRIPTION OF THE DRAWINGS

Embodiments of the invention are described further below by way of example only with reference to the accompanying Figures, of which:

FIG. 1 is a schematic diagram of a conveyor system;

FIG. 2 is a schematic diagram of a conveyor system, according to some embodiments;

FIG. 3 shows a perspective view the conveyor system represented with the schematic diagram in FIG. 2, showing part of a conveyor belt redirection system of the conveyor system and with part of the conveyor system represented schematically, according to some embodiments;

FIG. 4 shows a perspective view of part of the conveyor system of FIG. 3, according to some embodiments;

FIG. 5 shows a perspective view of the part of the conveyor system of FIG. 3, with a frame of the conveyor system hidden, according to some embodiments;

FIG. 6 shows a front view of part of the conveyor system of FIG. 3, according to some embodiments;

FIG. 7 shows a front view of part of the conveyor system of FIG. 3, with the frame of the conveyor system hidden, according to some embodiments;

FIG. 8 shows a perspective view of a trough idler, according to some embodiments;

FIG. 9 shows a perspective view of another trough idler, according to some embodiments;

FIG. 10 shows a side view of part of the conveyor system of FIG. 3, according to some embodiments;

FIG. 11 shows a side view of part of the conveyor system of FIG. 3, according to some embodiments;

FIG. 12 shows a side view of part of the conveyor system of FIG. 3, with the frame of the conveyor system hidden, according to some embodiments;

FIG. 13 shows a side view of part of the conveyor system of FIG. 3, with the frame of the conveyor system hidden, according to some embodiments;

FIG. 14 shows a planar view of a sagittal cross section of part of the conveyor system of FIG. 3, with the frame of the conveyor system hidden, according to some embodiments;

FIG. 15 shows another planar view of a sagittal cross section of part of the conveyor system of FIG. 3, with the frame of the conveyor system hidden, according to some embodiments;

FIG. 16 shows another planar view of a sagittal cross section of part of the conveyor system of FIG. 3, with the frame of the conveyor system hidden, according to some embodiments;

FIG. 17 shows a planar view of a sagittal cross section of part of the conveyor system of FIG. 3, according to some embodiments;

FIG. 18 shows another planar view of a sagittal cross section of part of the conveyor system of FIG. 3, according to some embodiments;

FIG. 19 shows a schematic diagram of a conveyor system, according to some embodiments;

FIG. 20 shows a schematic diagram of a conveyor system, according to some embodiments; and

FIG. 21 shows a schematic diagram of a conveyor system, according to some embodiments.

### DESCRIPTION OF EMBODIMENTS

### Overview of a Conveyor System Including a Change in Conveyor Belt Elevation

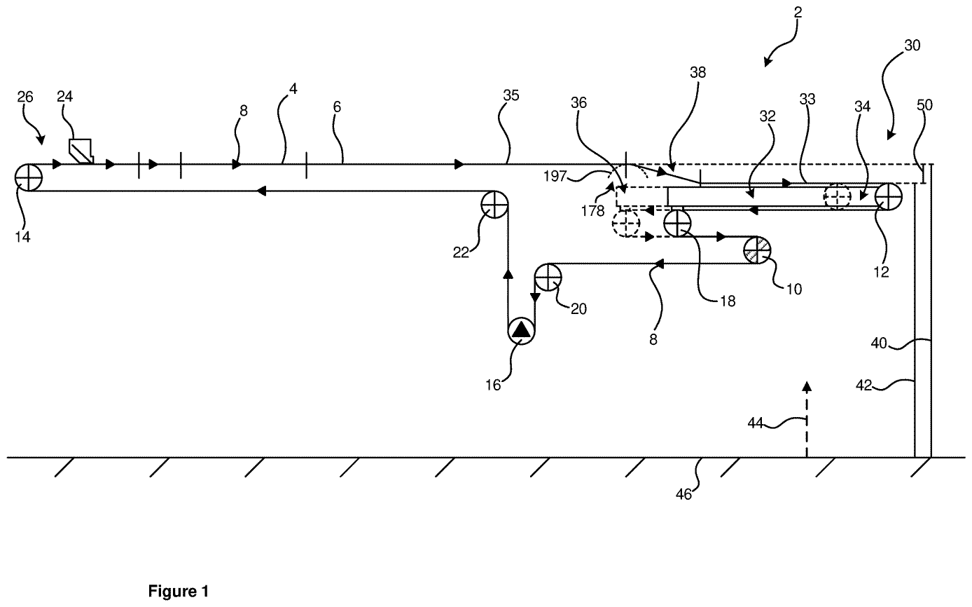

FIG. 1 is a schematic diagram of an exemplary conveyor system 2. The conveyor system 2 is a shuttle conveyor system that shapes a conveyor belt 4 into a trough to assist with conveying a material. The material may be a loose mined material. The conveyor belt 4 is arranged to form a closed-loop conveyor belt circuit 6. The conveyor belt 4 is directed through the conveyor belt circuit 6 using idlers (not shown) and pulleys. The conveyor system 2 includes a change in elevation 50 of the conveyor belt 4.

The conveyor belt 4 is driven in a drive direction 8 by a drive pulley 10. Upstream and downstream positional references can be made with reference to the drive direction 8 at a particular point of the conveyor belt circuit 6. The drive pulley 10 engages with the conveyor belt 4 such that rotation of the drive pulley 10 causes corresponding movement of the conveyor belt 4. The conveyor system 2 comprises a head pulley 12 and a tail pulley 14. The conveyor system 2 comprises a take-up pulley 16. The take-up pulley 16 is used to ensure the tension in the conveyor belt 4 is maintained within an appropriate operating range. The conveyor system 2 comprises a first bend pulley 18, a second bend pulley 20 and a third bend pulley 22. The pulleys of the conveyor system 2 redirect the conveyor belt 4 as it is driven in the drive direction 8, through the conveyor belt circuit 6.

They conveyor system 2 comprises a loading system 24. The material to be conveyed by the conveyor system 2 is loaded onto the conveyor belt 4 via the loading system 24.

The conveyor system 2 comprises a shuttle 32. The head pulley 12 is mounted to the shuttle 32. The shuttle 32 is moveable between an extended position 34 (shown in FIG. 1) and a retracted position 36 (shown in a dashed profile in FIG. 1). Control of the position of the shuttle 32 enables the material conveyed by the conveyor system 2 to be delivered to a number of different end locations (e.g. into different chutes).

Conveyor systems like that of FIG. 1 can include sections where the conveyor belt is supported at different elevations through the relevant conveyor belt circuit. For example, an upper surface of a portion 33 of the conveyor belt 4 supported by the shuttle 32 of FIG. 1 is at a lower elevation 42 than an upper elevation 40 of an upper surface of a portion 35 of the conveyor belt 4 supported by the conveyor system 2 upstream of the shuttle 32. The conveyor system 2 therefore comprises a transition portion 38 where the conveyor belt 4 transitions from the upper elevation 40 to the lower elevation 42. In other words, the conveyor belt 4 is directed through the change in elevation 50 at the transition portion 38. The upper elevation 40 and the lower elevation 42 are measured in an elevation direction 44 with respect to a common reference (e.g. in a direction perpendicular to a ground surface 46).

The conveyor belt 2 is shaped to form a trough by trough idlers towards the tail end 26, upstream of the loading system 24. The conveyor belt 2 is maintained in the trough through the transition portion 38, until it approaches the head pulley 12 towards a head end 30 of the conveyor system 2.

### Conveyor Systems Including Changes in Elevation

### Problems With Conveyor Systems Including Changes in Elevation

As described herein, conveyor systems can be subject to various constraints that, to some extent, influence the profile of the conveyor system and/or the conveyor belt circuit of the relevant conveyor system. As a result, some conveyor systems can include changes in elevation through which the conveyor belt of the conveyor system is directed.

For example, where the change in elevation is a decrease in elevation like the transition portion 38 of the conveyor system 2 of FIG. 1, the conveyor belt is directed through a concave down curve of a particular radius, followed by a concave up curve of another radius to accommodate the change in elevation.

Throughout this description, it will be understood that a curve may be referred to as concave down if a concavity of the curve is downwards. In other words, the curve may be referred to as a concave down curve if it has a generally concave profile with respect to an observational point that is below the curve (i.e. that is at an elevation that is less than the elevation(s) of the component(s) forming the curve). In some embodiments, such a curve may be said to be a convex curve. For example, a concave down curve may be considered a convex curve with respect to an observational point that is above the curve.

Throughout this description, it will be understood that a curve may be referred to as concave up if the concavity of the curve is upwards. In other words, the curve may be referred to as a concave up curve if it has a generally concave profile with respect to an observational point that is above the curve (i.e. that is at an elevation that is greater than the elevation(s) of the component(s) forming the curve). In some embodiments, such a curve may be said to be a convex curve. For example, a concave up curve may be considered a convex curve with respect to an observational point that is below the curve.

Maintaining a conveyor belt in a trough through the vertical curves of a change in elevation subjects the conveyor belt to stresses that cause the conveyor belt to form relatively complex curved shapes as it transits the change in elevation.

Throughout this description, it will be appreciated that a vertical curve may be considered to be a curve that involves a change in elevation in a vertical direction along a length of the curve. That is, a vertical curve may be considered to be a curve that involves a change in elevation with respect to a direction that is perpendicular to a reference plane (e.g. a direction that is perpendicular to a plane that is parallel to a ground surface). For example, where a conveyor belt is shaped into a curve with an elevation at one end that is higher than an elevation at another end, the conveyor belt can be said to form a vertical curve. Similarly, where a conveyor belt is shaped into a curve with an elevation at one end that is lower than an elevation at another end, the conveyor belt can be said to form a vertical curve.

As the trough-shaped belt is directed through the vertical curves, it is forced to temporarily flex outwards at its edges. That is, the conveyor belt is forced to flex out of the trough shape into which it is biased. Gravity, the weight of the conveyor belt and the weight of the material carried by the conveyor belt act against the outward flexing. However, the belt flexure and associated deformation of the conveyor belt can stretch the edges of the conveyor belt over acceptable limits (e.g. a rated edge tension). This can result in the conveyor belt being subject to overstressing at its edges, buckling and/or other non-recoverable bending, causing damage to the conveyor belt.

It is noted that as the conveyor belt is flattened out of the trough shape prior to passing the head pulley, edge tensions like this are typically not imparted on the belt as it transits the pulleys.

### Reducing Stresses Imparted on Conveyor Belts Through Changes in Elevation

The conveyor system described herein enables a significant reduction in the stresses imparted on the described conveyor belt when the conveyor belt is shaped into a trough and directed through a change in elevation during operation. The conveyor system supports the conveyor belt in a trough shape through a transition portion. An elevation of the conveyor belt changes through the transition portion. Specifically, the transition portion comprises an upward change in elevation and a subsequent downward change in elevation.

The described conveyor system includes a conveyor belt redirection system that redirects the conveyor belt of the conveyor system in a direction that is opposite to the required change in elevation before directing the conveyor belt through the required change in elevation. By doing so, the radius of one or more of the vertical curves through which the conveyor belt is directed are increased. One or more of these radii can be increased towards or above a threshold radius of the conveyor belt when shaped in the described trough, thereby reducing the edge tension of the conveyor belt as it transits the change in elevation.

The conveyor belt circuit of the described conveyor system includes a decrease in elevation. The conveyor belt redirection system directs the conveyor belt through an initial increase in elevation prior to a decrease in elevation. The net change in elevation is the same as would be the case where the conveyor belt redirection system was omitted; however, the radius of one or more of the vertical curves through which the conveyor belt is directed is larger than that through which it would have been directed without the disclosed conveyor belt redirection system. As a result, the edge tensions of the conveyor belt as it changes elevation during operation can be reduced and the operating life of the conveyor belt can be increased for a conveyor belt of a given grade.

While the constraints that require the change in elevation of the described conveyor system are, at least in part, a result of accommodating movement of a shuttle, it will be appreciated that the described conveyor belt redirection system also enables the reduction in stresses imparted on a conveyor belt when used in other contexts, unrelated to a shuttle conveyor, that involve a change in elevation of a conveyor belt when shaped into a trough.

Further, while the conveyor belt redirection system is described in the context of facilitating a decrease in elevation of a conveyor belt circuit, it will be appreciated that a similar conveyor belt redirection system may be used to facilitate an increase in elevation of the conveyor belt circuit of an alternative conveyor system. Such a conveyor belt redirection system may first direct the conveyor belt through an initial decrease in elevation prior to an increase in elevation. Again, the net change in elevation may be the same as would be the case where the conveyor belt redirection system was omitted; however, the radii of the vertical curves through which the conveyor belt would be directed would be larger than those through which it would have been directed without the conveyor belt redirection system.

### Overview of a Conveyor System 100

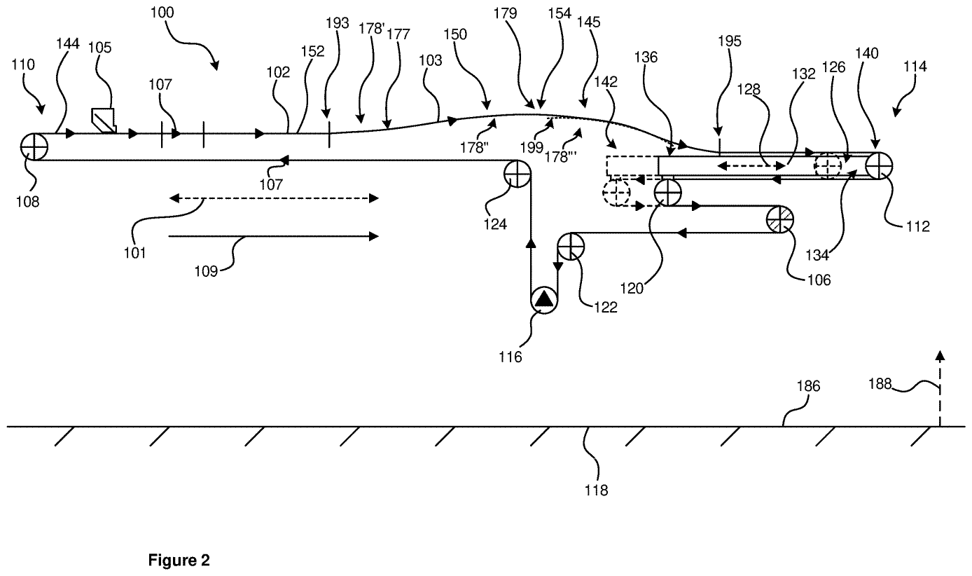

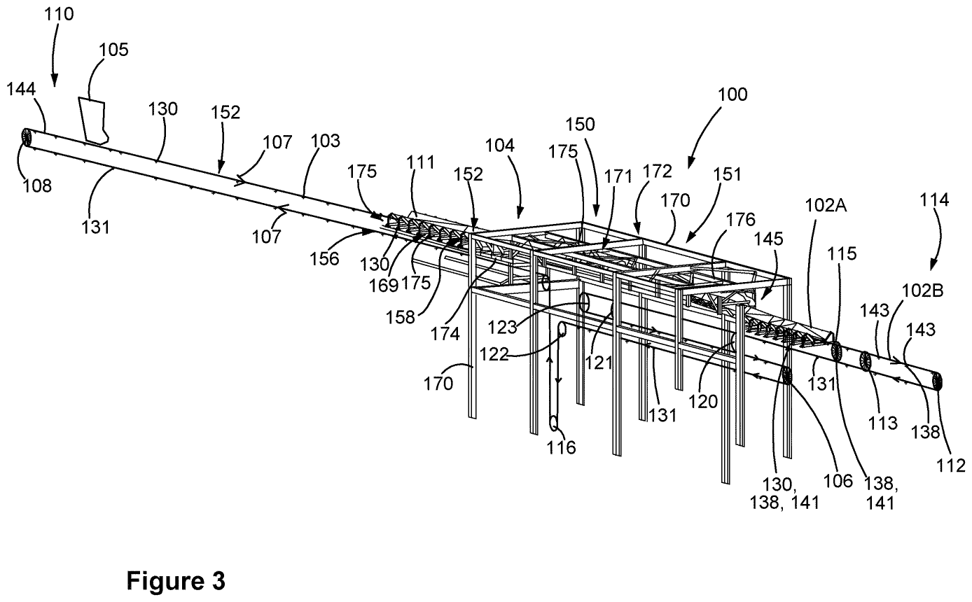

FIG. 2 is a schematic diagram of a conveyor system 100, according to some embodiments. FIGS. 3 to 18 show a number of views of the conveyor system 100 and/or one or more parts of the conveyor system 100.

The conveyor system 100 is configured to convey a material. The material may be a loose mined material. The conveyor system 100 extends in a conveyor system longitudinal direction 109. The conveyor system 100 extends from a tail end 110 to a head end 114. The conveyor system 100 extends in the conveyor system longitudinal direction 109 from the tail end 110 to the head end 114. The conveyor system 100 defines a conveyor system longitudinal axis 101. The conveyor system longitudinal axis 101 is parallel to the conveyor system longitudinal direction 109. The illustrated conveyor system longitudinal axis 101 is straight.

It will be appreciated that if the conveyor system 100 were to curve along its length, the conveyor system longitudinal direction 109 may be defined to curve to be parallel with a sagittal plane of the conveyor system 100, along its length. Similarly, in such embodiments, the conveyor system longitudinal axis 101 may curve to be generally parallel with the sagittal plane of the conveyor system 100, along its length.

The conveyor system 100 comprises a conveyor belt 102. A schematic of the conveyor belt 102 is shown in FIG. 2. FIGS. 3 to 5 show a perspective view of a first part 102A of the conveyor belt 102. A second part 102B of the conveyor belt 102 is represented schematically in each of FIGS. 3 to 5 and 10 to 13. The conveyor belt 102 is arranged to form a closed-loop conveyor belt circuit 103. The conveyor belt 102 is circulated through the conveyor belt circuit 103 as described herein.

The conveyor belt 102 comprises a carcass 111 (see FIG. 3). The carcass 111 comprises an outer cover. The outer cover comprises a polymer. For example, the outer cover may comprise a rubber. The outer cover defines an outer conveyor belt surface. The conveyor belt 102 comprises an inner cover. The inner cover comprises a polymer. For example, the inner cover may comprise a rubber. The inner cover defines an inner conveyor belt surface. It will be appreciated that the outer cover and the outer conveyor belt surface may be referred to as a top cover and a top conveyor belt surface respectively. Similarly, it will be appreciated that the inner cover and the inner conveyor belt surface may be referred to as a bottom cover and a bottom conveyor belt surface respectively. The conveyor belt 102 comprises a core. The carcass 111 may be said to comprise the core. The core is disposed between the outer cover and the inner cover. The conveyor belt 102 comprises a first lateral edge portion defining a first lateral edge and an opposing second lateral edge portion defining a second lateral edge. The carcass 111 may be said to comprise the first lateral edge portion and the second lateral edge portion.

The conveyor belt 102 has a number of conveyor belt characteristics. The conveyor belt 102 may be selected to suit a particular production process based on its conveyor belt characteristics. The conveyor belt characteristics comprise one or more of a distance between the outer conveyor belt surface and the inner conveyor belt surface, which may be referred to as a thickness of the conveyor belt 102, a distance between the first lateral edge and the second lateral edge, which may be referred to as a width of the conveyor belt 102, a thickness of the outer cover, a thickness of the inner cover, a material of the outer cover, a material of the inner cover, a surface finish of the outer cover, a dimension of the core and a material of the core.

In some embodiments, the width of the conveyor belt 102 may be about 1.8 m. In some embodiments, the width of the conveyor belt 102 may be 1 m, 1.1 m, 1.2 m, 1.3 m, 1.4 m, 1.5 m, 1.6 m, 1.7 m, 1.8 m, 1.9 m, 2.0 m, 2.1 m, 2.2 m, 2.3 m, 2.4 m, 2.5 m or 3 m. In some embodiments, the width of the conveyor belt 102 may be between 1 m and 3 m. In some embodiments, the thickness of the outer cover may be about 15 mm. In some embodiments, the thickness of the outer cover may be 10 mm, 11 mm, 12 mm, 13 mm, 14 mm, 15 mm, 16 mm, 17 mm, 18 mm, 19 mm or 20 mm. In some embodiments, the thickness of the outer cover may be between 10 mm and 20 mm. In some embodiments, the thickness of the inner cover may be about 5 mm. In some embodiments, the thickness of the inner cover may be about 6 mm. In some embodiments, the thickness of the inner cover may be 3 mm, 4 mm, 5 mm, 6 mm, 7 mm, 8 mm, 9 mm or 10 mm. In some embodiments, the thickness of the inner cover is between 3 mm and 10 mm.

One or more of the conveyor belt characteristics of a conveyor belt is influenced by the operating requirements of the particular production process for which the conveyor belt is used. For example, the thickness of the particular conveyor belt may need to be relatively large if the conveyor belt is going to be used in particularly strenuous conditions, to improve the lifespan of the conveyor belt during operation. This can be a particularly significant issue when the conveyor belt is supported in a trough as described herein. When a trough-shaped conveyor belt is driven through one or more radius of curvature, the edge tension of the conveyor belt at that region can increase. Where the radius of curvature is small enough (i.e. equal to or below a threshold radius), the edge tension may exceed an edge tension threshold, causing damage to the conveyor belt.

Without selecting a conveyor belt with appropriate conveyor belt characteristics (e.g. a thickness to accommodate the larger stresses associated with the radius of curvature), the conveyor belt may fail prematurely. However, selecting an appropriate conveyor belt can cause other disadvantages. For example, a conveyor belt with a larger thickness may have a greater mass. The energy requirements of the relevant conveyor system may therefore be greater than they otherwise would be if the conveyor belt with a smaller thickness could be used. The conveyor system 100 described herein enables a reduction in the stresses imparted on the conveyor belt 102 during use. This can increase the operating life of the conveyor belt 102, without necessitating a change in one or more conveyor belt characteristics, such as a thickness of the conveyor belt 102, that could have a detrimental effect to the conveyor system 100 (e.g. increased power consumption).

The conveyor system 100 comprises a conveyor system frame 104. The conveyor system frame 104 may be referred to as a frame of the conveyor system 100. The conveyor system frame 104 is configured to support a number of the components of the conveyor system 100, as described herein. A number of the components of the conveyor system frame 104 are hidden in the Figures.

The conveyor system 100 comprises a loading system 105. The material to be conveyed by the conveyor system 100 is loaded onto the conveyor belt 102 via the loading system 105. The loading system 105 controls a rate at which the material is loaded onto the conveyor belt 102. The loading system 105 may control the rate at which the material is loaded onto the conveyor belt 102 based on one or more of a mass of the material, a bulk density of the material and a velocity of the conveyor belt 102. The loading system 105 is positioned at the tail end 110 of the conveyor system 100.

The conveyor system 100 comprises a drive pulley 106. A schematic representation of the drive pulley 106 is shown in FIGS. 2 to 5 and 10 to 13. The drive pulley 106 is configured to rotate about a drive pulley axis. The drive pulley axis is orthogonal to the conveyor system longitudinal axis 101. The drive pulley axis is orthogonal to a vertical axis.

The conveyor system 100 comprises a drive system (not shown). The drive system is supported by the conveyor system frame 104. The drive system is connected to the drive pulley 106. The drive system is operable to cause rotation of the drive pulley 106 about the drive pulley axis in a rotation direction. In other words, the drive system is operable to rotate the drive pulley 106 in the rotation direction. The rotation direction may be a clockwise direction. The rotation direction may be a counter-clockwise direction. In some embodiments, the drive system is operable to rotate the drive pulley 106 about the drive pulley axis in both a clockwise and a counter-clockwise direction.

The drive pulley 106 is configured to engage with the conveyor belt 102. In particular, the drive pulley 106 engages the inner conveyor belt surface. In the illustrated embodiment, the drive pulley 106 frictionally engages with the conveyor belt 102 such that rotation of the drive pulley 106 causes corresponding movement of the conveyor belt 102. The drive pulley 106 is rotated in the rotation direction to cause the conveyor belt 102 to move in a drive direction 107. It will be understood that in some embodiments, the drive pulley 106 may engage with the conveyor belt 102 in another way. For example, the drive pulley 106 may comprise teeth, with the conveyor belt 102 comprising corresponding internal grooves.

The conveyor system 100 comprises a tail pulley 108. A schematic representation of the tail pulley 108 is shown in FIGS. 2 and 3. The tail pulley 108 is supported by the conveyor system frame 104. The tail pulley 108 is positioned at the tail end 110 of the conveyor system 100. The tail pulley 108 is configured to rotate about a tail pulley axis. The tail pulley axis is parallel to the drive pulley axis. The tail pulley 108 is configured to support the conveyor belt 102 and to rotate about the tail pulley axis as the conveyor belt 102 is driven through the conveyor belt circuit 103.

The conveyor system 100 comprises a head pulley 112. A schematic representation of the head pulley 112 is shown in FIGS. 2 and 3. The head pully 112 is disposed at the head end 114 of the conveyor system 100. The head pulley 112 is configured to rotate about a head pulley axis. The head pulley axis is parallel to the drive pulley axis. The head pulley 112 is configured to support the conveyor belt 102 and to rotate about the head pulley axis as the conveyor belt 102 is driven through the conveyor belt circuit 103.

The conveyor system 100 comprises a take-up pulley 116. A schematic representation of the take-up pulley 116 is shown in FIGS. 2 to 5 and 10 to 13. The take-up pulley 116 is configured to rotate about a take-up pulley axis. The take-up pulley axis is parallel to the drive pulley axis. The take up pulley 116 is configured to be moved to control the belt tension of the conveyor belt 102 during operation. The take-up pulley 116 can be moved downwards (i.e. towards a ground surface 118, shown in FIG. 2) to increase the belt tension of the conveyor belt 102. The take-up pulley 116 can be moved upwards (i.e. away from the ground surface 118) to reduce the belt tension of the conveyor belt 102.

The conveyor system 100 comprises a plurality of bend pulleys. In particular, the conveyor system 100 comprises a first bend pulley 120. The first bend pulley 120 is configured to change a direction of movement of the conveyor belt 102 as the conveyor belt 102 passes the first bend pulley 120. The conveyor system 100 comprises a second bend pulley 122. The second bend pulley 122 is configured to change a direction of movement of the conveyor belt 102 as the conveyor belt 102 passes the second bend pulley 122. The conveyor system 100 comprises a third bend pulley 124. The third bend pulley 124 is configured to change a direction of movement of the conveyor belt 102 as the conveyor belt 102 passes the third bend pulley 124.

The conveyor system 100 comprises a transition portion 145. The conveyor system 100 supports the conveyor belt 102 in a trough shape through the transition portion 145. An elevation of the conveyor belt 102 changes through the transition portion 145. The transition portion 145 comprises an upward change in elevation. In other words, there is an upwards change in elevation of the conveyor belt 102 at the transition portion 145. The transition portion 145 comprises a subsequent downward change in elevation. In other words, there is a downwards change in elevation of the conveyor belt 102 at the transition portion. The downward change in elevation is downstream of the upward change in elevation. The downward change in elevation is greater than the upward change in elevation. The conveyor belt 102 is therefore supported at a lower elevation downstream of the transition portion 145 than upstream of the transition portion 145. The conveyor belt 102 is directed through a number of vertical curves 178 at the transition portion 145, as described herein. In some embodiments, a vertical curve 178 of the conveyor belt 102 and/or one or more other components of the conveyor system may be considered to comprise a curve in a vertical alignment between to locations. For example, an alignment of the conveyor belt 102 may curve in a vertical plane as it transits a length of the conveyor system 100. Such a curve may be referred to as a vertical curve. A vertical curve may comprise a concave up curve. A vertical curve may comprise a concave down curve.

### Idlers 130

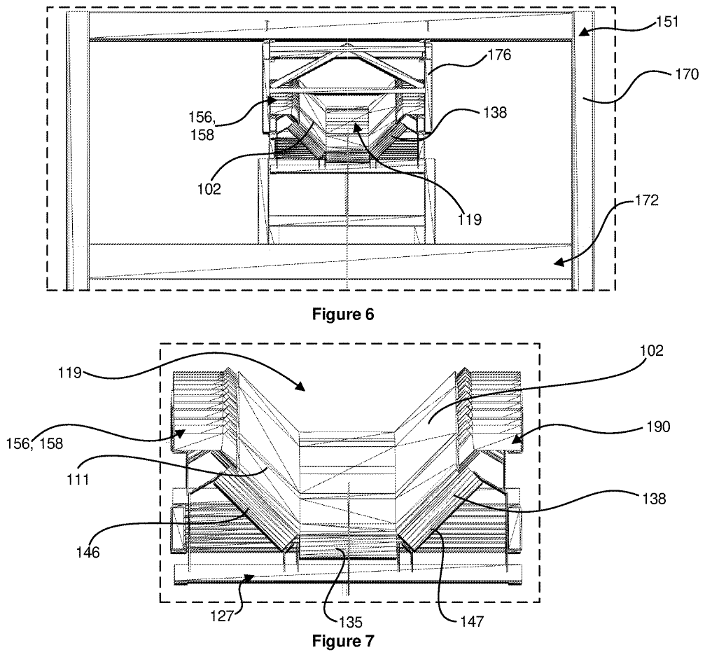

The conveyor system 100 comprises a plurality of idlers 130. A number of the plurality of idlers 130 are represented schematically in FIGS. 3 to 5 and 10 to 15. In particular, a number of the idlers 130 are represented schematically as crosses in FIGS. 3 to 5 and 10 to 13. FIGS. 3 to 18 show perspective views of a number of the plurality of idlers 130. Some of the idlers 130 are mounted to the conveyor system frame 104. The idlers 130 support the conveyor belt 102. In particular, the idlers 130 support the conveyor belt 102 between the tail pulley 108 and the head pulley 112 as the conveyor belt 102 transits the conveyor belt circuit 103. A number of the idlers 130 that support the conveyor belt 102 while it conveys material are trough idlers. The trough idlers hold the conveyor belt 102 such that the conveyor belt 102 forms a trough 119 (refer to FIG. 6) as it transits the relevant trough idlers. A number of the idlers 130 that support the conveyor belt 102 may be flat idlers.

The conveyor system 100 comprises a number of support idlers 131. The support idlers 131 are shown schematically in FIGS. 3 to 5 and 10 to 13. Some of the support idlers 131 are mounted to the conveyor system frame 104. The support idlers 131 are configured to support the conveyor belt 102 as it is returned from the head pulley 112 to the tail pulley 108. The conveyor belt 102 is unloaded when supported by the support idlers 131. In other words, the support idlers support the conveyor belt 102 when the conveyor belt 102 is not loaded with the material.

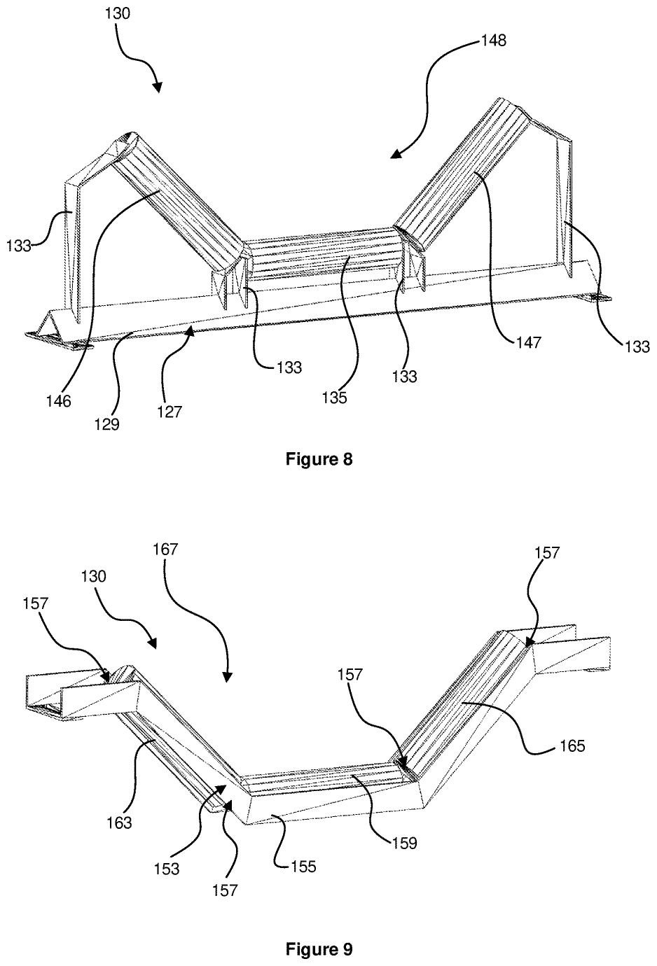

As described herein, a number of the idlers 130 that support the conveyor belt 102 as the conveyor belt 102 is driven from the tail pulley 108 to the head pulley 112 are trough idlers. FIG. 8 shows a perspective view of one of the trough idlers 130. The trough idler 130 of FIG. 8 is in the form of a standing idler. A standing idler is configured to be supported by a support structure disposed underneath the standing idler.

The trough idler 130 comprises a trough idler frame 127. The trough idler frame 127 may be referred to as a standing idler frame. The trough idler frame 127 comprises a frame base 129. The frame base 129 may be referred to as a standing idler base. The frame base 129 is configured to be mounted to the relevant support structure. The trough idler frame 127 comprises a plurality of roller support portions 133. The roller support portions 133 are connected to the frame base 129 and extend away from the frame base 129. In some embodiments, the roller support portions 133 are integrally formed with the frame base 129.

The trough idler 130 comprises a central roller 135. The trough idler frame 127 is configured to support the central roller 135. The central roller 135 is cylindrical. The central roller 135 is configured to rotate about a central roller axis (not shown) when supported by the trough idler frame 127.

The trough idler 130 comprises a pair of opposed angled rollers 146, 147. In particular, the trough idler 130 comprises a first angled roller 146 and a second angled roller 147. The first angled roller 146 is supported at a first end of the central roller 135, by respective roller support portions 133. The first angled roller 146 is cylindrical. The first angled roller 146 is configured to rotate about a first angled roller axis (not shown) when supported by the trough idler 130. The first angled roller axis is transverse to the central roller axis. The second angled roller 147 is supported at a second end of the central roller 135, by respective roller support portions 133. The second angled roller 147 is cylindrical. The second angled roller 147 is configured to rotate about a second angled roller axis (not shown) when supported by the trough idler 130. The second angled roller axis is transverse to the central roller axis. The roller support portions 133 are configured to support an end of a respective roller such that the rollers 135, 146, 147 define a trough 148. When the conveyor belt 102 is supported by the trough idler 130, the conveyor belt 102 forms the trough 119, as described herein.

FIG. 9 shows a perspective view of another trough idler 130 of the plurality of idlers 130. The trough idler 130 of FIG. 9 is in the form of a hanging idler. A hanging idler is configured to be supported from a support structure disposed above the hanging idler.

The trough idler 130 of FIG. 9 comprises a trough idler frame 153. The trough idler frame 153 may be referred to as a hanging idler frame. The trough idler frame 153 comprises a frame base 155. The frame base 155 may be referred to as a hanging idler base. The frame base 155 is configured to be mounted to the relevant support structure. The trough idler frame 153 comprises a plurality of roller support portions 157. The roller support portions 157 are connected to the frame base 155. In some embodiments, the roller support portions 157 are integrally formed with the frame base 155.

The trough idler 130 of FIG. 9 comprises a central roller 159. The trough idler frame 153 is configured to support the central roller 159. The central roller 159 is cylindrical. The central roller 159 is configured to rotate about a central roller axis (not shown) when supported by the trough idler frame 153.

The trough idler 130 of FIG. 9 comprises a pair of opposed angled rollers 163, 165. In particular, the trough idler 130 comprises a first angled roller 163 and a second angled roller 165. The first angled roller 163 is supported at a first end of the central roller 159. The first angled roller 163 is cylindrical. The first angled roller 163 is configured to rotate about a first angled roller axis (not shown) when supported by the trough idler 130. The first angled roller axis is transverse to the central roller axis. The second angled roller 165 is supported at a second end of the central roller 159. The second angled roller 165 is cylindrical. The second angled roller 165 is configured to rotate about a second angled roller axis (not shown) when supported by the trough idler 130. The second angled roller axis is transverse to the central roller axis. The roller support portions 157 are configured to support an end of a respective roller such that the rollers 159, 163, 165 define a trough 167. When the conveyor belt 102 is supported by the trough idler 130 of FIG. 9, the conveyor belt 102 forms the trough 119, as described herein.

In some embodiments, where one of the plurality of idlers 130 is described herein to be a trough idler, it may take the form of the trough idler 130 described with reference to FIG. 8 or the trough idler 130 described with reference to FIG. 9. That is, the idler 130 may be a standing idler or a hanging idler.

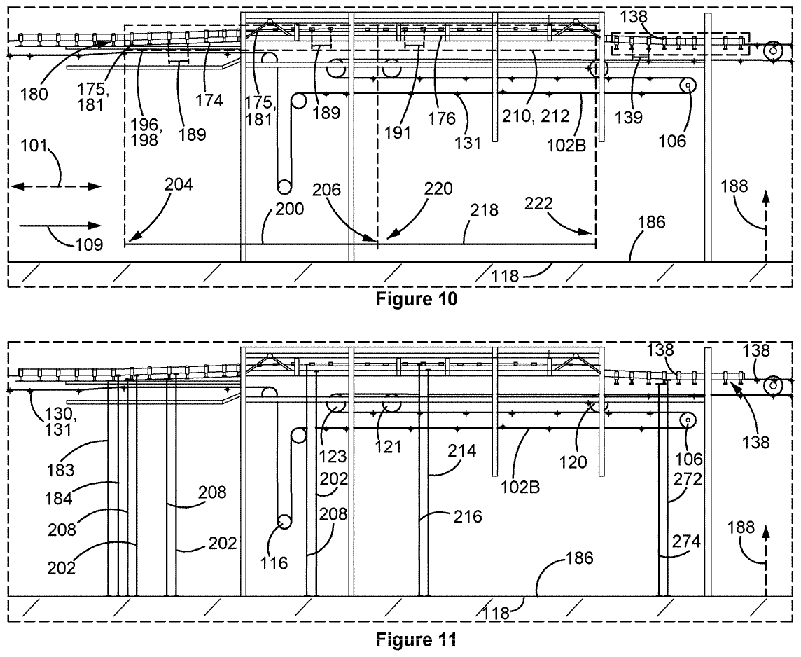

When one of the plurality of idlers 130 is described herein to be supported at a particular elevation, it will be appreciated that the respective idler 130 is supported by the frame 104 or a part thereof, and that this elevation is measured with respect to a reference plane 186 (shown, for example, in FIGS. 2 and 10) and a reference portion of the respective idler 130. The elevation corresponds to a distance between the reference plane 186 and the reference portion of the respective idler 130, measured in a direction that is orthogonal to the reference plane 186. This direction may be referred to as an elevation direction 188. In some embodiments, the reference plane 186 is tangential to a portion of the ground surface 118. The reference plane 186 may be generally parallel to the ground surface 118. In some embodiments, the reference plane 186 is parallel to a linear belt path 152 of the conveyor system 100. In some embodiments, the reference portion of the respective idler 130 may correspond to a central point of the central roller of that idler 130. The central point may lie on the central roller axis, at a point equidistant from each lateral end of the central roller. In some embodiments, the reference portion of the respective idler 130 may correspond to a point where the idler 130 is mounted to the frame 104.

Where elevations of different idlers 130 are compared herein, it will be understood that the respective elevations are determined based on the distances between the reference plane 186 and corresponding reference portions of the different idlers 130. For example, the elevation of one of the idlers 130 is equal to a distance between the reference plane 186 and the reference portion of that idler 130 (e.g. the central point of the central roller of that trough idler 130), measured in the elevation direction 188. Similarly, the elevation of another of the idlers 130 is equal to a distance between the reference plane 186 and the reference portion of that idler 130 (e.g. the central point of the central roller of that idlers 130), measured in the elevation direction 188.

The conveyor system 100 comprises a plurality of idler mounting portions 175. In particular, the frame 104 comprises a number of the idler mounting portions 175. Each idler mounting portion 175 is configured to support an idler 130 of the plurality of idlers 130. That is, an idler 130 of the plurality of idlers 130 may be mountable to a respective idler mounting portion 175. When the frame 104 is constructed, each idler mounting portion 175 may be said to be positioned at a respective elevation. Further, each idler mounting portion 175 is configured to support the corresponding idler 130 at a particular elevation.

Each of the plurality of idler mounting portions 175 may be associated with a respective reference portion. The reference portion may be associated with a portion the respective idler mounting portion 175 that is directly involved with the mounting of the respective idler 130. For example, in embodiments where an idler 130 mounts to the relevant idler mounting portion 175 with one or more bolted joints, the reference portion of the idler mounting portion 175 may be associated with a portion of the idler mounting portion 175 that facilitates one of the bolted joints (e.g. the reference portion may be a centre point of a hole of the idler mounting portion 175 that receives a bolt).

When one of the plurality of idler mounting portions 175 is described herein to be positioned at a particular elevation, it will be appreciated that this elevation is measured with respect to the reference plane 186 and the reference portion of the respective idler mounting portion 175. The elevation corresponds to a distance between the reference plane 186 and the reference portion of the respective idler mounting portion 175, measured in the elevation direction 188.

Where elevations of different idler mounting portions 175 are compared herein, it will be understood that the respective elevations are determined based on the distances between the reference plane 186 and corresponding reference portions of the different idler mounting portion 175. For example, the elevation of one of the idler mounting portion 175 is equal to a distance between the reference plane 186 and the reference portion of that idler mounting portion 175, measured in the elevation direction 188. Similarly, the elevation of another of the idlers 130 is equal to a distance between the reference plane 186 and the reference portion of that idler mounting portion 175, measured in the elevation direction 188.

### Shuttle 126

The conveyor system 100 comprises a shuttle 126. The shuttle 126 is represented schematically in FIGS. 2, 14 and 16. The shuttle 126 is supported by the conveyor system frame 104. The shuttle 126 is configured to move along a shuttle axis 128. The shuttle axis 128 is parallel with the conveyor system longitudinal axis 101. The shuttle 126 comprises a shuttle body 132. The shuttle body 132 is shown schematically in FIGS. 2, 14 and 16. The shuttle body 132 extends from a first shuttle body end portion 134 to a second shuttle body end portion 136.

The head pulley 112 is mounted to the shuttle 126. In particular, the head pulley 112 is mounted to the shuttle body 132 at the first shuttle body end portion 134. The first bend pulley 120 is mounted to the shuttle 126. In particular, the first bend pulley 120 is mounted to the shuttle body 132 at the second shuttle body end portion 136. The first bend pulley 120 is mounted to an underside of the shuttle body 132.

The shuttle 126 comprises a subset of the idlers 130 of the conveyor system 100. These idlers 130 may be referred to as shuttle idlers 138. In other words, the shuttle 126 comprises a plurality of shuttle idlers 138. The plurality of shuttle idlers 138 are configured to support the conveyor belt 102 when the conveyor belt 102 is conveying the material.

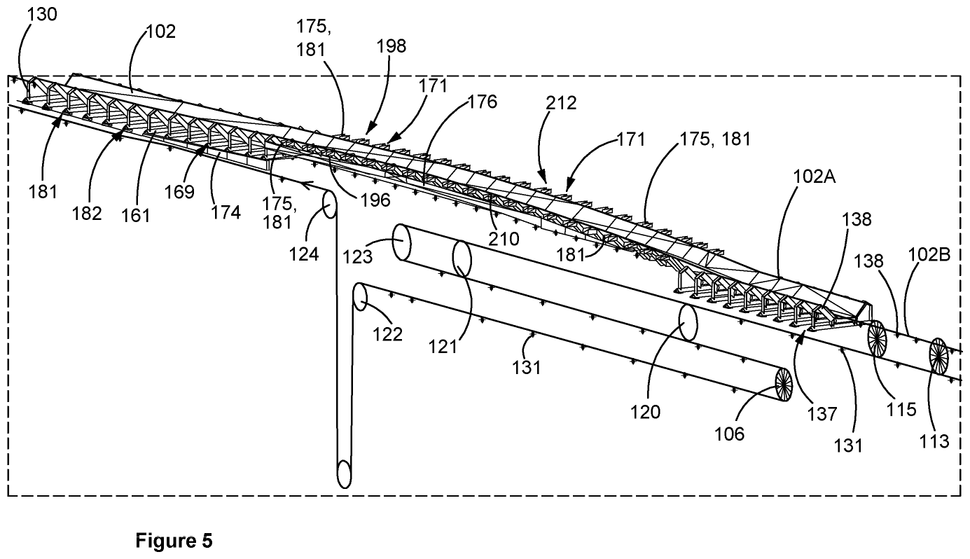

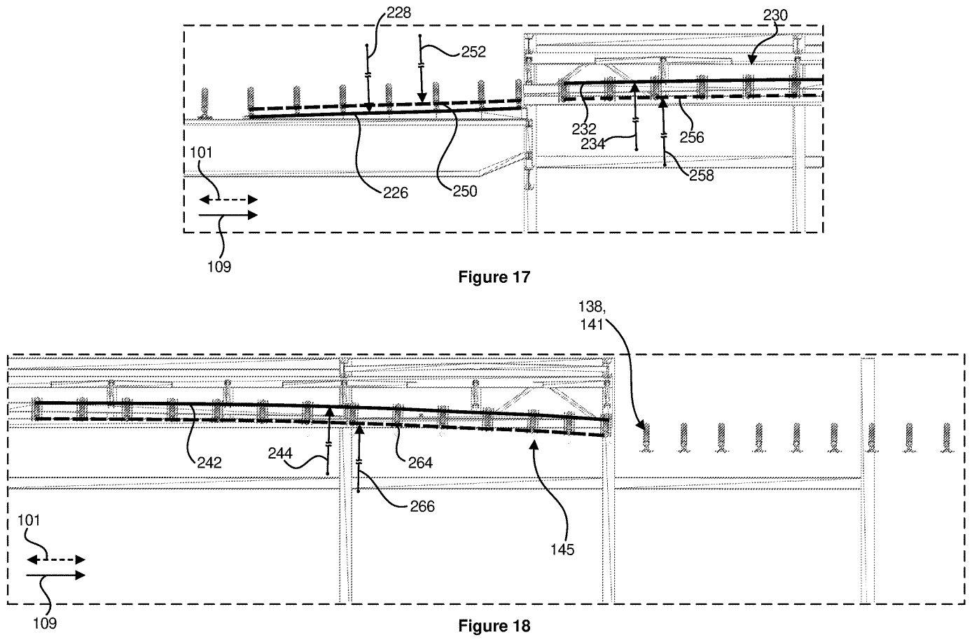

A number of the shuttle idlers 138 are shown schematically as crosses in FIGS. 3 to 5. Three-dimensional representations of a number of the shuttle idlers 138 are shown in FIGS. 3 to 7 and 10 to 18. The shuttle idlers 138 are mounted to the shuttle body 132. The plurality of idler mounting portions 175 comprises a number of shuttle idler mounting portions 137 (see FIGS. 5, 17). The shuttle body 132 comprises the plurality of shuttle idler mounting portions 137. The shuttle idlers 138 are configured to be mounted to the shuttle idler mounting portions 137. The shuttle idler mounting portions 137 are positioned between the first shuttle body end portion 134 and the second shuttle body end portion 136.

When mounted to the shuttle idler mounting portions 137, the shuttle idlers 138 are spaced apart along the shuttle body 132 between the first shuttle body end portion 134 and the second shuttle body end portion 136. One or more of the shuttle idlers 138 is separated from an adjacent shuttle idler 138 by a shuttle idler spacing 139. The shuttle idler spacing 139 is associated with a spacing between the shuttle idler mounting portions 137.

In some embodiments, each of the plurality of shuttle idlers 138 is separated from the adjacent shuttle idler(s) 138 by the same distance. In other words, the shuttle idler spacing(s) 139 of each shuttle idler 138 is/are the same. In some embodiments, one or more of the shuttle idlers spacing(s) 139 is about 3 m. The shuttle idlers 138 are configured to support the conveyor belt 102 when loaded with the material.

The plurality of shuttle idlers 138 comprises a plurality of shuttle trough idlers 141. In other words, the shuttle trough idlers 141 are a subset of the shuttle idlers 138. The shuttle trough idlers 141 are configured to support the conveyor belt 102 when loaded with the material. The shuttle trough idlers 141 are trough idlers mounted to the shuttle body 132. The shuttle trough idlers 141 may be similar to or the same as the trough idler 130 described with reference to FIG. 8 or the trough idler 130 described with reference to FIG. 9.

The plurality of shuttle idlers 138 comprises a plurality of flat shuttle idlers 143. The flat shuttle idlers 143 are shown schematically in FIG. 3. The flat shuttle idlers 143 are mounted to the shuttle body 132 between the shuttle trough idlers 141 and the head pulley 112. The flat shuttle idlers 143 are configured to support the conveyor belt 102 when loaded with the material.

The shuttle 126 comprises a shuttle movement system (not shown). The shuttle movement system enables the shuttle to move along the shuttle axis 128. The shuttle movement system may comprise one or more of a wheel, a bearing and a track.

The conveyor system 100 comprises a shuttle drive system (not shown). The shuttle drive system is connected to the shuttle 126. The shuttle drive system is operable to cause movement of the shuttle 126. In particular, the shuttle drive system is operable to move the shuttle 126 between an extended position 140 and a retracted position 142. In other words, the shuttle 126 is configured to be moved between the extended position 140 and the retracted position 142. The shuttle 126 may be controllably moved between a number of intermediate shuttle positions that are between the extended position 140 and the retracted position 142.

The conveyor system frame 104 is configured to support the shuttle 126. The conveyor system frame 104 comprises a shuttle supporting portion (hidden in the Figures). The shuttle supporting portion is configured to support the shuttle 126 when the shuttle 126 is in the extended position 140. The shuttle supporting portion is configured to support the shuttle 126 when the shuttle 126 is in the retracted position 142. The shuttle supporting portion is configured to support the shuttle 126 when the shuttle is in the intermediate shuttle position(s). In other words, the shuttle supporting portion is configured to support the shuttle 126 as the shuttle 126 is moved between the extended position 140 and the retracted position 142.

The head pulley 112 is represented schematically in FIGS. 2 and 3. FIGS. 3 to 5 also show a head pulley intermediate position schematic representation 113 and a head pulley retracted position schematic representation 115. The head pulley intermediate position schematic representation 113 shows an exemplary position of the head pulley 112 when the shuttle 126 is in an intermediate shuttle position. The head pulley retracted position schematic representation 115 shows an exemplary position of the head pulley 112 when the shuttle 126 is in the retracted position 142. When the shuttle 126 is in an intermediate shuttle position, the head pulley 112 is closer to the tail pulley 108 than when the shuttle 126 is in the extended position 140. When the shuttle 126 is in the retracted position 142, the head pulley 112 is closer to the tail pulley 108 than when the shuttle 126 is in the extended position 140 and when the shuttle 126 is in the intermediate position.

FIGS. 3 to 5 show a first bend pulley intermediate position schematic representation 121 and a first bend pulley retracted position schematic representation 123. The first bend pulley intermediate position schematic representation 121 shows an exemplary position of the first bend pulley 120 when the shuttle 126 is in an intermediate shuttle position. The first bend pulley retracted position schematic representation 123 shows an exemplary position of the first bend pulley 120 when the shuttle 126 is in the retracted position 142.

### Conveyor Belt Circuit 103

The conveyor belt circuit 103 may be described with reference to the path through which a reference portion of the conveyor belt 102 passes during operation of the conveyor system 100. A reference portion 144 of the conveyor belt 102 may be considered to start the conveyor belt circuit 103 near, but downstream of, the tail pulley 110 and upstream of the loading system 105. The drive pulley 106 is driven by the drive system to cause the conveyor belt 102 move in the drive direction 107 to complete the conveyor belt circuit 103. The reference portion 144 is supported by the described pulleys, and the plurality of idlers 130 as it is driven through the conveyor belt circuit 103.

The reference portion 144 is moved from the tail pulley 108 along the conveyor belt circuit 103. The idlers 130 supporting the conveyor belt 102 transition from flat idlers to trough idlers as the reference portion 144 is moved away from the tail pulley 108, towards the loading system 105. The reference portion 144 is moved towards the loading system 105 and the material is loaded onto the conveyor belt 102 as it passes the loading system 105. The reference portion 144 is moved until it meets the head pulley 112. That is, the reference portion 144 is moved away from the tail pulley 108, towards the head pulley 112. The reference portion 144 is directed through the linear belt path 152 and a serpentine belt path 154 as it is driven from the tail pulley 108 towards the head pulley 112. The reference portion 144 is supported by a number of the idlers 130 as it is driven from the tail pulley 108 to the head pulley 112. These idlers 130 can be positioned to control the profile of the conveyor belt 102, as described herein.

A direction of motion of the reference portion 144 is changed at the head pulley 112. The reference portion 144 transits the head pulley 112, after which it is moved away from the head pulley 112 and towards the first bend pulley 120 (which is also towards the tail pulley 108) with further movement of the conveyor belt 102 through the conveyor belt circuit 103.

The direction of motion of the reference portion 144 is changed at the first bend pulley 120. The reference portion 144 transits the first bend pulley 120, after which it is moved away from the first bend pulley 120, towards the drive pulley 106 (which is also towards the head pulley 112) with further movement of the conveyor belt 102 through the conveyor belt circuit 103.

The direction of motion of the reference portion 144 is changed at the drive pulley 106. The reference portion 144 transits the drive pulley 106, after which it is moved away from the drive pulley 106, towards the second bend pulley 122 with further movement of the conveyor belt 102 through the conveyor belt circuit 103.

The direction of motion of the reference portion 144 is changed at the second bend pulley 122. The reference portion 144 transits the second bend pulley 122, after which it is moved away from the second bend pulley 122, towards the take-up pulley 116 with further movement of the conveyor belt 102 through the conveyor belt circuit 103. The reference portion 144 is moved downwards, towards the take-up pulley 116.

The direction of motion of the reference portion 144 is changed at the take-up pulley 116. The reference portion 144 transits the take-up pulley 116, after which it is moved away from the take-up pulley 116, towards the third bend pulley 124 with further movement of the conveyor belt 102 through the conveyor belt circuit 103. The reference portion 144 is moved upwards, towards the third bend pulley 124.

The direction of motion of the reference portion 144 is changed at the third bend pulley 124. The reference portion 144 transits the third bend pulley 124, after which it is moved towards the tail pulley 108 with further movement of the conveyor belt 102 through the conveyor belt circuit 103, to complete the conveyor belt circuit 103.

### Mounting Portion Paths

A mounting portion path may be defined by connecting reference portions of a number of the idler mounting portions 175 with one or more virtual line(s). In particular, the mounting portion path may be defined by connecting the reference portions of a number of the idler mounting portions 175 with a curve. The curve may have a continuous gradient. The curve may be represented by a spline. A number of example mounting portion paths 226, 232, 244 are shown in FIGS. 17 and 18.

A portion of a mounting portion path may be referred to as concave up if the concavity of the mounting portion path is upwards. That is, if the portion of the mounting portion path forms a generally concave profile with reference to an observational point that is above the portion of the mounting portion path (i.e. that is at an elevation that is greater than the elevations of one or more of the relevant idler mounting portions 175). Where the portion of the mounting portion path is defined by a curve, the portion may be referred to as concave up if a gradient of the portion (determined with reference to an appropriate coordinate system) increases along the length of the portion.

A portion of a mounting portion path may be referred to as concave down if the concavity of the mounting portion path is downwards. That is, if the portion of the mounting portion path forms a generally concave profile with reference to an observational point that is below the portion of the mounting portion path (i.e. that is at an elevation that is less than the elevations of the relevant idler mounting portions 175). Where the portion of the mounting portion path is defined by a curve, the portion may be referred to as concave down if a gradient of the portion (determined with reference to an appropriate coordinate system) decreases along the length of the portion.

For the purposes of this description, the mounting portion paths are considered to extend in the conveyor system longitudinal direction 109 with gradients determined with reference to an x-axis that extends in the conveyor system longitudinal direction 109, and a y-axis that extends in the elevation direction 188.

### Idler Paths

An idler path may be defined by connecting the reference portions of a number of the idlers 130 with one or more virtual line(s). In particular, the idler path may be defined by connecting the reference portions of a number of the idlers 130 with a curve. The curve may have a continuous gradient. The curve may be represented by a spline. A number of example idler paths 250, 258, 266 are shown in FIGS. 17 and 18.

A portion of an idler path may be referred to as concave up if the concavity of the idler path is upwards. That is, if the portion of the idler path forms a generally concave profile with reference to an observational point that is above the portion of idler path (i.e. that is at an elevation that is greater than the elevations of one or more of the relevant idlers 130). Where the portion of the idler path is defined by a curve, the portion may be referred to as concave up if a gradient of the portion (determined with reference to an appropriate coordinate system) increases along the length of the portion.

A portion of an idler path may be referred to as concave down if the concavity of the idler path is downwards. That is, if the portion of the idler path forms a generally concave profile with reference to an observational point that is below the portion of the idler path (i.e. that is at an elevation that is less than the elevations of the relevant idlers 130). Where the portion of the idler path is defined by a curve, the portion may be referred to as concave down if a gradient of the portion (determined with reference to an appropriate coordinate system) decreases along the length of the portion.

For the purposes of this description, the idler paths are considered to extend in the conveyor system longitudinal direction 109 with gradients determined with reference to an x-axis that extends in the conveyor system longitudinal direction 109, and a y-axis that extends in the elevation direction 188.

### Conveyor Belt Redirection System 150

The conveyor system 100 of FIG. 2 is a variation on the conveyor system 2 of FIG. 1, incorporating a conveyor belt redirection system 150 of the present disclosure. That is, the conveyor system 100 comprises a conveyor belt redirection system 150. The conveyor belt redirection system 150 redirects the conveyor belt 102 first upwardly and then downwardly, prior to the conveyor belt 102 being delivered to the shuttle idlers 138. In this way, the radius of one or more of the vertical curves 178 through which the conveyor belt 102 is directed is increased, compared to those through which the conveyor belt 102 would be directed without the conveyor belt redirection system 150. As a result, the edge tensions of the conveyor belt 102 as it is moved onto the shuttle 126 (i.e. as it is directed through a change in elevation) during operation can be reduced and the operating life of the conveyor belt 102 can be increased.

An example of the increase in the radius of one of the vertical curves 178 through which the conveyor belt is directed is illustrated in FIGS. 1 and 2. FIG. 1 shows a radius of curvature 197 of a vertical curve 178 through which the conveyor belt 4 of the conveyor system 2 of FIG. 1 is directed. FIG. 2 shows a radius of curvature 199 of a vertical curve 178 through which the conveyor belt 102 of the conveyor system 100 of FIG. 2 is directed. As can be seen in FIGS. 1 and 2, the radius of curvature 199 of the conveyor belt 102 of FIG. 2 is larger than the radius of curvature 197 of the conveyor belt 4 of FIG. 1. This larger radius of curvature is enabled, at least in part, by the conveyor belt redirection system 150 described herein.

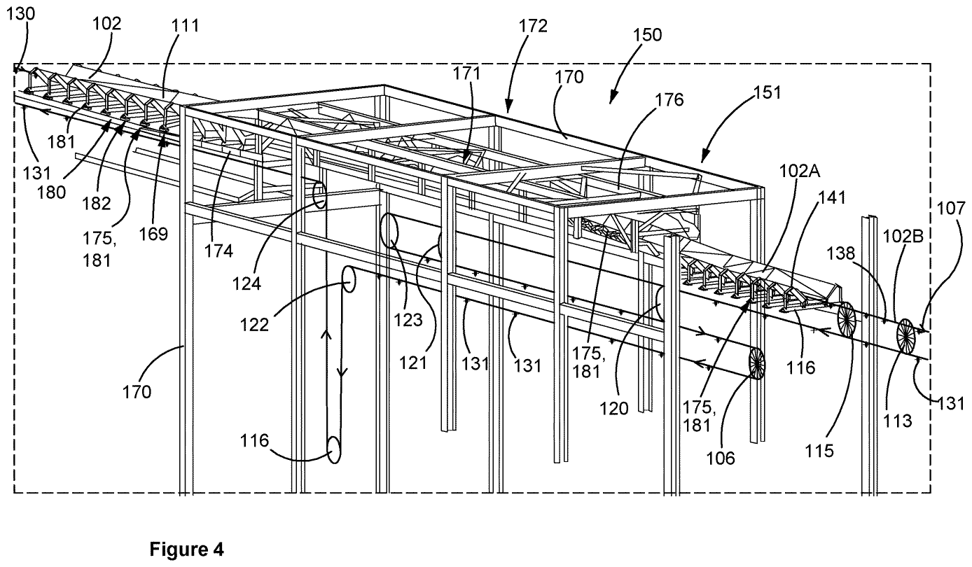

A number of parts of the conveyor belt redirection system 150 are shown in FIGS. 3 to 18. Part of the conveyor belt redirection system 150 is hidden in FIGS. 3 to 5, to assist with ensuring a number of the components of the conveyor belt redirection system 150 are clearly represented. In FIGS. 3 and 4, the conveyor belt redirection system 150 is shown supporting the first part 102A of the conveyor belt 102.

Referring to FIGS. 2 and 3, the conveyor belt redirection system 150 is configured to redirect the conveyor belt 102 from the linear belt path 152 through the serpentine belt path 154. The linear belt path 152 is a path with a generally linear profile. In other words, a gradient of the linear belt path 152 may be constant, or may be within a specified range around a constant gradient. The serpentine belt path 154 is a path with a generally curved profile. In other words, a gradient of the serpentine belt path 154 changes along a length of the serpentine belt path 154.

### Support Structure 151

Referring to FIGS. 3, 4, 6 and 7, the conveyor belt redirection system 150 comprises a support structure 151. The support structure 151 is configured to support one or more parts of the conveyor system 100. In particular, the support structure 151 supports a number of the plurality of idlers 130 such that the idlers 130 support the conveyor belt 102 through a path with an initial increase in elevation and a subsequent decrease in elevation, prior to the conveyor belt 102 being moved onto the shuttle 126. The support structure may be referred to as a frame. The support structure 151 may be referred to as a conveyor belt redirection system frame. The support structure 151 comprises support members 170. The support members 170 are configured to be assembled to form a load bearing structure 172 of the support structure 151. The load bearing structure 172 is configured to support one or more other components of the support structure 151 and/or the conveyor system 100.

The support structure 151 comprises a standing idler support structure 174. The standing idler support structure 174 is mountable to the load bearing structure 172. The standing idler support structure 174 supports one or more other components of the conveyor system 100, as described herein.

The support structure 151 comprises a hanging idler support structure 176. The hanging idler support structure 176 is mountable to the load bearing structure 172. The hanging idler support structure 176 supports one or more other components of the conveyor system 100, as described herein.

The support structure 151 is configured to support the shuttle 126. In some embodiments, the support structure 151 comprises the shuttle supporting portion described herein.

### Idlers 156 of the Conveyor Belt Redirection System 150

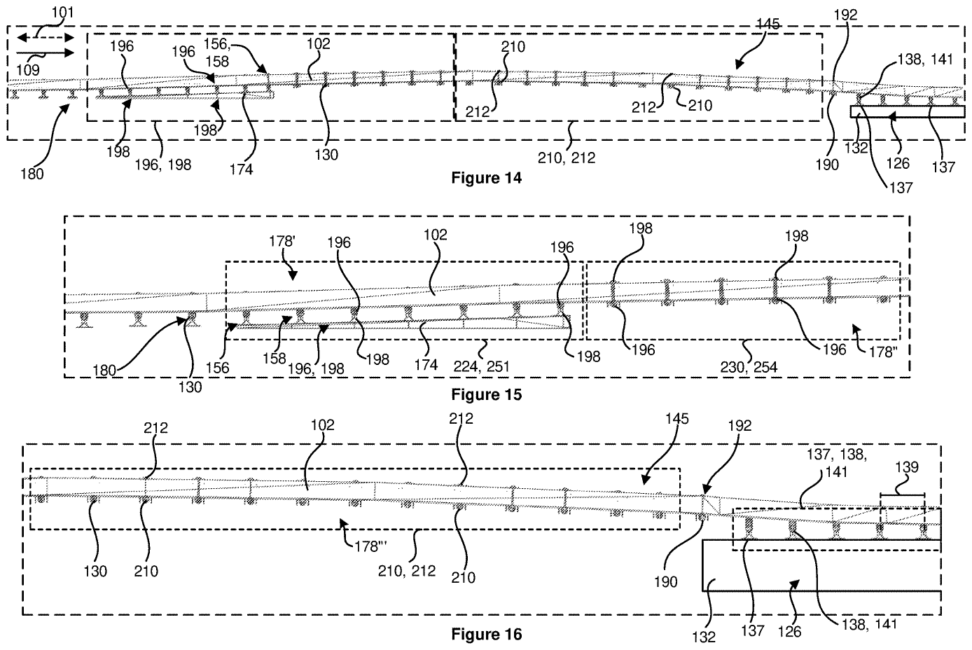

The conveyor belt redirection system 150 comprises a plurality of idlers 156 (shown in FIGS. 3 and 14). The idlers 156 of the conveyor belt redirection system 150 are a subset of the plurality of idlers 130 of the conveyor system 100. In other words, the plurality of idlers 130 of the conveyor system 100 comprises the plurality of idlers 156 of the conveyor belt redirection system 150. The plurality of idlers 156 comprises a plurality of trough idlers 158. In other words, the conveyor belt redirection system 150 comprises the plurality of trough idlers 158. The trough idlers 158 are configured to support the conveyor belt 102. The plurality of idlers 156 comprises the shuttle idlers 138.

One or more of the trough idlers 158 may be similar to, or the same as the trough idler 130 described herein with reference to FIG. 8. One or more of the trough idlers 158 may be similar to, or the same as the trough idler 130 described with reference to FIG. 9.

The plurality of trough idlers 158 comprises a number of standing idlers 169. The standing idlers 169 are connected to the standing idler support structure 174. The plurality of trough idlers 158 comprises a number of hanging idlers 171. The hanging idlers 171 are connected to the hanging idler support structure 176.

### The Plurality of Trough Idlers 158

FIGS. 3 to 7 and 10 to 18 show views of a number of parts of the conveyor belt redirection system 150 when constructed. A part of the conveyor belt redirection system 150 is hidden in the Figures. As described herein, the conveyor belt redirection system 150 comprises a plurality of trough idlers 158. An upstream part of the support structure 151, that supports a number of the trough idlers 158, is hidden in the Figures. Similarly, a downstream part of the support structure 151, that supports a number of the trough idlers 158, is hidden in the Figures.

Referring to FIGS. 3, 5 and 10, the support structure 151 comprises a plurality of idler mounting portions 175. The plurality of idler mounting portions 175 comprises a plurality of trough idler mounting portions 181. In other words, the trough idler mounting portions 181 are a subset of the idler mounting portions 175. The trough idler mounting portions 181 are configured to support the trough idlers 158. In other words, a trough idler mounting portion 181 is a portion of the support structure 151 to which one of the trough idlers 158 is mountable. In some embodiments, each of the idler mounting portions 175 of the conveyor belt redirection system 150 is in the form of a trough idler mounting portion 181.

Referring to FIGS. 14 to 16, the plurality of trough idlers 158 comprises an initial trough idler 180. The plurality of trough idler mounting portions 181 comprises an initial trough idler mounting portion 182. In other words, the support structure 151 comprises an initial trough idler mounting portion 182. The initial trough idler 180 is mountable to the initial trough idler mounting portion 182. The initial trough idler 180 may be mounted to the initial trough idler mounting portion 182 using a bolted joint, for example.

When the conveyor belt redirection system 150 is constructed, the initial trough idler mounting portion 182 may be said to be disposed at an initial trough idler mounting portion elevation 183 (shown in FIG. 11). When the conveyor belt redirection system 150 is constructed, the initial trough idler 180 may be said to be supported at an initial elevation 184 (shown in FIG. 11). In other words, the initial trough idler mounting portion 182 is configured to enable the initial trough idler 180 to be mounted at the initial elevation 184.

Again, referring to FIGS. 14 to 16, the plurality of trough idlers 158 comprises an end trough idler 190. The plurality of trough idler mounting portions 181 comprises an end trough idler mounting portion 192. In other words, the support structure 151 comprises the end trough idler mounting portion 192. The end trough idler 190 is mountable to the end trough idler mounting portion 192. The end trough idler 190 may be mounted to the end trough idler mounting portion 192 using a bolted joint, for example.

When the conveyor belt redirection system 150 is constructed, the end trough idler 190 is downstream of the initial trough idler 180. In other words, the end trough idler 190 is closer to the head pulley 112 than the initial trough idler 180. When the conveyor belt redirection system 150 is constructed, the end trough idler mounting portion 192 is downstream of the initial trough idler mounting portion 182. In other words, the end trough idler mounting portion 192 is closer to the head pulley 112 than the initial trough idler mounting portion 182.

When the conveyor belt redirection system 150 is constructed, the end trough idler mounting portion 192 may be said to be disposed at an end trough idler mounting portion elevation 185 (shown in FIG. 13). When the conveyor belt redirection system 150 is constructed, the end trough idler 190 may be said to be supported at an end elevation 194 (shown in FIG. 13). In other words, the end trough idler mounting portion 192 is configured to enable the end trough idler 190 to be mounted at the end elevation 194.

Referring to FIGS. 2 and 14 to 16, the conveyor system 100 comprises the transition portion 145. The transition portion 145 is a portion of the conveyor system 100 at which an elevation of the conveyor belt 102 changes whilst the conveyor belt 102 is maintained in the trough shape. The transition portion 145 extends between a start 193 and an end 195. The start 193 may be considered a first end of the transition portion 145. The end 195 may be considered a second end of the transition portion 145. The conveyor belt 102 is directed through a number of vertical curves 178 between the start 193 and the end 195 of the transition portion 145. The conveyor belt support system 150 defines at least part of the transition portion 145. The length of the conveyor belt 102 that spans the transition portion 145 at a particular time may be referred to as a transitional length.

In some embodiments, the transition portion 145 may be considered to extend from the initial trough idler 180 to one of the shuttle idlers 138. The relevant shuttle idler 138 may be the shuttle idler 138 at which the conveyor belt 102 transitions from having a curved longitudinal profile to a linear longitudinal profile. In some embodiments, the transition portion 145 may be considered to extend from near the initial trough idler 180 to near the relevant shuttle idler 138. For example, the transition portion may be considered to extend from a midpoint between the initial trough idler 180 and the immediately upstream idler 130, to a midpoint between the relevant shuttle idler 138 and the immediately downstream shuttle idler 138.

### First Plurality of Intermediate Trough Idlers 196

The plurality of trough idlers 158 comprises a first plurality of intermediate trough idlers 196. The first plurality of intermediate trough idlers 196 are shown in FIGS. 10, 14 and 15. In some embodiments, the first plurality of intermediate trough idlers 196 comprises a particular number of trough idlers 196. The number of trough idlers 196 in the first plurality of intermediate trough idlers 196 may be a number greater than or equal to 1. In the illustrated embodiment, the first plurality of intermediate trough idlers 196 comprises 13 trough idlers 196.

The plurality of trough idler mounting portions 181 comprises a first plurality of intermediate trough idler mounting portions 198. The support structure 151 comprises the first plurality of intermediate trough idler mounting portions 198. The standing idler support structure 174 comprises a number of the first plurality of intermediate trough idler mounting portions 198. The hanging idler support structure 176 comprises a number of the first plurality of intermediate trough idler mounting portions 198. A number of the first plurality of intermediate trough idlers 196 are standing idlers. These trough idlers 196 are mountable to the standing idler support structure 174. A number of the first plurality of intermediate trough idlers 196 are hanging idlers. These trough idlers 196 are mountable to the hanging idler support structure 176.

One or more trough idler 196 of the first plurality of intermediate trough idlers 196 is mountable to a respective idler mounting portion 198 of the first plurality of intermediate trough idler mounting portions 198. One or more trough idler 196 of the first plurality of intermediate trough idlers 196 may be mounted to the respective idler mounting portion 198 of the first plurality of intermediate trough idler mounting portions 198 using a bolted joint.

Referring to FIG. 11, when the conveyor belt redirection system 150 is constructed, each trough idler 196 of the first plurality of intermediate trough idlers 196 may be said to be supported at a respective first intermediate trough idler elevation 202. In other words, the idler mounting portions 198 are configured to enable the trough idlers 196 to be mounted at respective first intermediate trough idler elevations 202. The first intermediate trough idler elevations 202 are greater than or equal to the initial elevation 184. In some embodiments, one or more of the first intermediate trough idler elevations 202 may be less than the initial elevation 184.

When the conveyor belt redirection system 150 is constructed, each trough idler mounting portion 198 of the first plurality of intermediate trough idler mounting portions 198 may be said to be supported at a respective first intermediate trough idler mounting portion elevation 208. The first intermediate trough idler mounting portion elevations 208 are greater than or equal to the initial elevation 184.

The first plurality of intermediate trough idler mounting portions 198 comprises a particular number of idler mounting portions 198. The number of idler mounting portions 198 may be a number greater than or equal to 1. In the illustrated embodiment, the first plurality of intermediate trough idler mounting portions 198 comprises 13 idler mounting portions 198. In some embodiments, the first plurality of intermediate trough idler mounting portions 198 comprises the same number of idler mounting portions 198 as the first plurality of intermediate trough idlers 196 comprises trough idlers 196. In some embodiments, the first plurality of intermediate trough idler mounting portions 198 comprises a different number of idler mounting portions 198 as the first plurality of intermediate trough idlers 196 comprises trough idlers 196. For example, in some embodiments, the first plurality of intermediate trough idler mounting portions 198 comprises a greater number of idler mounting portions 198 than the first plurality of intermediate trough idlers 196 comprises trough idlers 196.

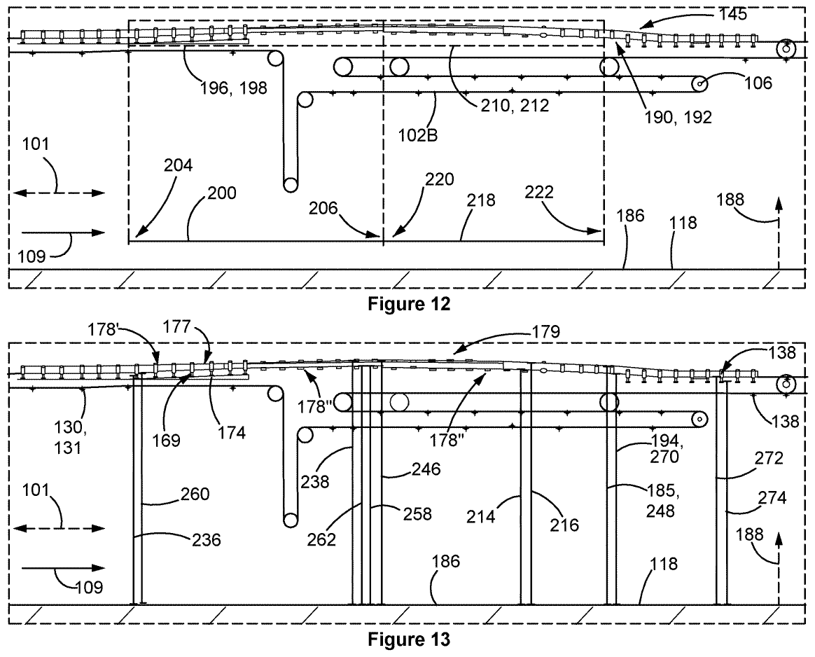

Referring to FIG. 12, the first plurality of intermediate trough idler mounting portions 198 are positioned along a first longitudinal length 200 of the conveyor system 100. The first longitudinal length 200 extends parallel to the conveyor longitudinal axis 101. The first longitudinal length 200 is downstream of the initial trough idler 180 in the conveyor system longitudinal direction 109. The first longitudinal length 200 may be referred to as a first longitudinal length of the support structure 151. The first longitudinal length 200 may be referred to as a first longitudinal length of the conveyor belt redirection system 150. Therefore, when the first plurality of intermediate trough idlers 196 are mounted to the first plurality of intermediate trough idler mounting portions 198, the first plurality of intermediate trough idlers 198 may be said to be positioned along a first longitudinal length 200 of the conveyor belt redirection system 150.

When the conveyor belt redirection system 150 is constructed, the first plurality of intermediate trough idler mounting portions 198 are positioned at successively increasing elevations 208 as the first longitudinal length 200 is traversed from an upstream end 206 to a downstream end 208. In other words, the first intermediate trough idler mounting portion elevations 208 increase along the first longitudinal length 200.

The first plurality of intermediate trough idler mounting portions 198 is therefore configured to enable the first plurality of intermediate trough idlers 196 to be supported at successively increasing elevations 202 along the first longitudinal length 200. In other words, the first intermediate trough idler elevations 202 increase along the first longitudinal length 200 in the conveyor system longitudinal direction 109. When the conveyor belt redirection system 150 is constructed, the first plurality of intermediate trough idlers 196 are therefore supported at successively increasing elevations along the first longitudinal length 200.

It will be appreciated that in some embodiments, one or more of the idler mounting portions 198 of the first plurality of intermediate trough idler mounting portions 198 may be positioned at a common elevation, relative to the reference plane 146, as an immediately preceding idler mounting portion 198. That is, while a trend in the elevation of the first plurality of intermediate trough idler mounting portions 198 along the first longitudinal length 200 may be an increase in elevation, it will be understood that each idler mounting portion 198 of the first plurality of intermediate trough idler mounting portions 198 does not necessarily need to be at a higher elevation than the immediately preceding idler mounting portion 198.

It will also be appreciated that in some embodiments, one or more of the trough idlers 196 of the first plurality of intermediate trough idlers 196 may be positioned at a common elevation, relative to the reference plane 146, as an immediately preceding trough idler 196. That is, while a trend in the elevation of the first plurality of intermediate trough idlers 196 along the first longitudinal length 200 may be an increase in elevation, it will be understood that each trough idler 196 of the first plurality of intermediate trough idlers 196 does not necessarily need to be at a higher elevation than the immediately preceding trough idler 196.

When the conveyor belt redirection system 150 is constructed, the first plurality of intermediate trough idler mounting portions 198 are downstream of the initial trough idler mounting portion 182. In other words, the first plurality of intermediate trough idler mounting portions 198 are closer to the head pulley 112 than the initial trough idler mounting portion 182. When the conveyor belt redirection system 150 is constructed, the first plurality of intermediate trough idlers 196 are downstream of the initial trough idler 180. In other words, the first plurality of intermediate trough idlers 196 are closer to the head pulley 112 than the initial trough idler 180.

When mounted to the first plurality of intermediate trough idler mounting portions 198, the first plurality of intermediate trough idlers 196 are spaced apart along the support structure 151. Referring to FIG. 10, one or more of the first plurality of intermediate trough idlers 196 is separated from an adjacent intermediate trough idler 196 by a first spacing 189. The first spacing 189 is a distance. The first spacing may be measured by connecting the relevant intermediate trough idlers 196 with a straight line. The first spacing 189 is associated with a spacing between the intermediate trough idler mounting portions 198. For example, in some embodiments, the relevant intermediate trough idler mounting portions 198 are separated by the first spacing 189. As a result, the corresponding intermediate trough idlers 196 may also be separated by a distance equal to the first spacing 189. The first spacing 189 may therefore be measured by connecting the relevant intermediate trough idler mounting portions 198 with a straight line.

In some embodiments, each of the first plurality of intermediate trough idler mounting portions 198 is separated from the adjacent intermediate trough idler mounting portion(s) 198 by the same distance. In some embodiments, each of the first plurality of intermediate trough idlers 196 is separated from the adjacent intermediate trough idler 196 by the same distance. In some embodiments, the first spacing 189 is about 3 metres. In some embodiments, the first spacing 189 is 1 metre, 1.5 metres, 2 metres, 2.5 metres, 3 metres, 3.5 metres, 4 metres, 4.5 metres, 5 metres or more than 5 metres. In some embodiments, the first spacing 189 is between 1 and 10 metres or between 2 and 5 metres. In some embodiments, the first spacing 189 is proportional to a desired curvature of the conveyor belt 102.

### First Concave Up Mounting Portion Path 226

Referring to FIGS. 15 and 17, when the support structure 151 is constructed, a first subset 224 of the first plurality of intermediate trough idler mounting portions 198 defines a concave up curve. That is, the first subset 224 of the first plurality of intermediate trough idler mounting portions 192 defines a concave up mounting portion path 226. In particular, a curve connecting the respective reference point of each mounting portion 198 of the first subset 224 defines the concave up mounting portion path 226. The concave up mounting portion path 226 has a concave up profile. The concave up mounting portion path 226 has a continuous gradient. The concave up mounting portion path 226 may be referred to as a first concave up mounting portion path 226.

The gradient of the concave up mounting portion path 226 increases along its length in conveyor system longitudinal direction 109. In other words, the gradient of the concave up mounting portion path 226 increases when traversing the concave up mounting portion path 226 away from the initial trough idler mounting portion 182, in the conveyor system longitudinal direction 109. The concave up mounting portion path 226 has a first radius of curvature 228. The first radius of curvature 228 is equal to or greater than a first threshold radius. The first threshold radius is a radius at which an edge tension of the conveyor belt 102, when shaped to form the trough 119, is below an edge tension threshold. The edge tension threshold is a force. In some embodiments, the first threshold radius is about 263 metres. In some embodiments, the first threshold radius is about 100 metres, 200 metres, 220 metres, 240 metres, 260 metres, 280 metres, 300 metres or 400 metres. In some embodiments, the first threshold radius is between 100 metres and 400 metres or between 200 metres and 300 metres. In some embodiments, the edge tension threshold force is about 421.2 kN. In some embodiments, the edge tension threshold force is about 200 kN, 250 kN, 300 kN, 350 kN, 400 kN, 450 kN, 500 kN, 550 kN or 600 kN. In some embodiments, the edge tension threshold force is between 200 kN and 600 kN or between 400 kN and 500 kN.

### First Concave Down Mounting Portion Path 232

Referring to FIGS. 16 and 17, when the support structure 151 is constructed, a second subset 230 of the first plurality of intermediate trough idler mounting portions 198 defines a concave down curve. That is, the second subset 230 of the first plurality of intermediate trough idler mounting portions 198 defines a concave down mounting portion path 232. In particular, a curve connecting the respective reference point of each mounting portion 198 of the second subset 230 defines the concave down mounting portion path 232. The concave down mounting portion path 232 has a concave down profile. The concave down mounting portion path 232 has a continuous gradient. The concave down mounting portion path 232 may be referred to as a first concave down mounting portion path.

The gradient of the concave down mounting portion path 232 decreases along its length in the conveyor system longitudinal direction 109. In other words, the gradient of the concave down mounting portion path 232 decreases when traversing the concave down mounting portion path 232 away from the initial trough idler mounting portion 182, in the conveyor system longitudinal direction 109. The concave down mounting portion path 232 has a second radius of curvature 234. The second radius of curvature 234 is equal to or greater than a second threshold radius. The second threshold radius is a radius at which an edge tension of the conveyor belt 102, when shaped to form the trough 119, is below a second edge tension threshold. The second edge tension threshold is a force. The second edge tension threshold may be equal to the first edge tension threshold. The second threshold radius may be equal to the first threshold radius.

The concave up mounting portion path 226 and the concave down mounting portion path 232 form an ascending mounting portion path. The ascending mounting portion path extends from a first mounting portion elevation 236 to a first peak mounting portion elevation 238. The first mounting portion elevation 236 is equal to or greater than the initial elevation 184. The first peak mounting portion elevation 238 is greater than the initial elevation 184. The first peak mounting portion elevation 238 is greater than the first mounting portion elevation 236.

### First Concave up Idler Path 250

Referring to FIGS. 15 and 17, when the support structure 151 is constructed, the first plurality of intermediate trough idler mounting portions 198 support the first plurality of intermediate trough idlers 196. When mounted to the support structure 151, a first subset 251 of the first plurality of intermediate trough idlers 196 defines a concave up curve. That is, the first subset 251 of the first plurality of intermediate trough idlers 196 defines a concave up idler path 250. In particular, a curve connecting the respective reference point of each idler 196 of the first subset 251 defines the concave up idler path 250. The concave up idler path 250 has a concave up profile. The concave up idler path 250 has a continuous gradient. The concave up idler path 250 may be referred to as a first concave up idler path. The conveyor belt 102 is moved through a curved path corresponding to the concave up idler path 250 as it is driven across the first subset 251 of the first plurality of intermediate trough idlers 196.

The gradient of the concave up idler path 250 increases along its length in the conveyor system longitudinal direction 109. In other words, the gradient of the concave up idler path 250 increases when traversing the concave up idler path 250 away from the initial trough idler 180, in the conveyor system longitudinal direction 109. The concave up idler path 250 has a first radius of curvature 252. The first radius of curvature 252 is equal to or greater than a first threshold radius. The first threshold radius is a radius at which an edge tension of the conveyor belt 102, when supported by the idlers 130 and shaped to form the trough 119 at the concave up idler path 250, is below an edge tension threshold.

As the first radius of curvature 252 is equal to or greater than the first threshold radius, the edge tensions in the conveyor belt 102 as it is directed through a concave path corresponding to the concave up idler path 250 will remain equal to or below the edge tension threshold. With the edge tension threshold corresponding to a tension above which damage is caused to the conveyor belt 102, damage to the conveyor belt 102 can be reduced by directing it through this concave path.

### First Concave Down Idler Path 256

When the support structure 151 is constructed, a second subset 254 of the first plurality of intermediate trough idlers 196 defines a concave down curve. That is, the second subset 254 of the first plurality of intermediate trough idlers 196 defines a concave down idler path 256. In other words, when the first plurality of intermediate trough idlers 196 is supported by the first plurality of intermediate trough idler mounting portions 198, the first plurality of intermediate trough idlers 196 defines the concave down idler path 256. The concave down idler path 256 may be referred to as a first concave down idler path. A curve connecting the respective reference point of each idler 196 of the second subset 254 defines the concave down idler path 256. The concave down idler path 256 has a concave down profile. The concave down idler path 256 has a continuous gradient. The conveyor belt 102 is moved through a curved path corresponding to the concave down idler path 256 as it is driven across the second subset 254 of the first plurality of intermediate trough idlers 196.

The gradient of the concave down idler path 256 decreases along its length in the conveyor system longitudinal direction 109. In other words, the gradient of the concave down idler path 256 decreases when traversing the concave down idler path 256 away from the initial trough idler mounting portion 182, in the conveyor system longitudinal direction 109. The concave down idler path 256 has a second radius of curvature 258. The second radius of curvature 258 is equal to or greater than a second threshold radius. The second threshold radius is a radius at which an edge tension of the conveyor belt 102, when supported by the idlers 130 and shaped to form the trough 119, is below a second edge tension threshold. The second edge tension threshold may be equal to the first edge tension threshold. The second threshold radius may be equal to the first threshold radius.

As the second radius of curvature 258 is equal to or greater than the second threshold radius, the edge tensions in the conveyor belt 102 as it is directed through a concave path corresponding to the concave down mounting idler 256 will remain equal to or below the edge tension threshold. With the edge tension threshold corresponding to a tension above which damage is caused to the conveyor belt 102, damage to the conveyor belt 102 can be reduced by directing it through this concave path.

The concave up idler path 250 and the concave down idler path 256 form an ascending idler path. The ascending idler path is contiguous. Referring to FIG. 13, the ascending idler path extends from a first elevation 260 to a peak elevation 262. The first elevation 260 is equal to or greater than the initial elevation 184. The peak elevation 262 is greater than the initial elevation 184. The peak elevation 262 is greater than the first elevation 260.

As the conveyor belt 102 is directed across the first plurality of intermediate trough idlers 196, it is directed through an upward change in elevation. The upward change in elevation corresponds to the ascending idler path of the intermediate trough idlers 196 that support the conveyor belt 102.

A number of the first plurality of intermediate trough idlers 196 support the conveyor belt 102 through one or more vertical curves 178. In particular, the first plurality of intermediate trough idlers 196 support the conveyor belt 102 through a first concave up vertical curve 178′ and a first concave down vertical curve 178″. By doing so, the first plurality of intermediate trough idlers 196 direct the conveyor belt 102 through the upward change in elevation. The conveyor system 100 may therefore be said to direct the conveyor belt 102 through the first concave up vertical curve 178′ and the first concave down vertical curve 178″ at the upward change in elevation.

The first concave up vertical curve 178′ and the first concave down vertical curve 178″ span at least part of the upward change in elevation of the conveyor belt 102. The conveyor belt 102 is supported in the first concave up vertical curve 178′ by the first subset 251 of the first plurality of intermediate trough idlers 196. The conveyor belt 102 is supported in the first concave down vertical curve 178″ by the second subset 254 of the first plurality of intermediate trough idlers 196.

The first concave up vertical curve 178′ has an associated radius of curvature. The radius of curvature is equal to or greater than a threshold radius. The threshold radius is a radius at which an edge tension of the conveyor belt 102, when passed through the first vertical curve 178′ shaped to form the trough 119, is below the edge tension threshold. In some embodiments, the threshold radius is about 263 metres. In some embodiments, the threshold radius is about 100 metres, 200 metres, 220 metres, 240 metres, 260 metres, 280 metres, 300 metres or 400 metres. In some embodiments, the threshold radius is between 100 metres and 400 metres or between 200 metres and 300 metres.

The first concave down vertical curve 178″ has an associated radius of curvature. The radius of curvature is equal to or greater than the threshold radius described with reference to the first concave up vertical curve 178′.

### Second Plurality of Intermediate Trough Idlers 210

Referring to FIGS. 10, 14 and 16, the plurality of trough idlers 158 comprises a second plurality of intermediate trough idlers 210. In some embodiments, the second plurality of intermediate trough idlers 210 comprises a particular number of trough idlers 210. The particular number of trough idlers may be a number greater than or equal to 1. In the illustrated embodiment, the second plurality of intermediate trough idlers 210 comprises 13 trough idlers 210. In some embodiments, the first plurality of intermediate trough idlers 196 comprises more trough idlers 196 than the second plurality of intermediate trough idlers 210. In some embodiments, the first plurality of intermediate trough idlers 196 comprises an equal number of trough idlers 196 to the second plurality of intermediate trough idlers 210. In some embodiments, the first plurality of intermediate trough idlers 196 comprises less trough idlers 196 than the second plurality of intermediate trough idlers 210.

The plurality of trough idler mounting portions 181 comprises a second plurality of intermediate trough idler mounting portions 212. The support structure 151 comprises the second plurality of intermediate trough idler mounting portions 212. The hanging idler support structure 176 comprises a number of the second plurality of intermediate trough idler mounting portions 212. A number of the second plurality of intermediate trough idlers 210 are hanging idlers. These trough idlers are mountable to the hanging idler support structure 176. In some embodiments, all of the second plurality of intermediate trough idlers 210 are hanging idlers. In some embodiments, a number of the second plurality of intermediate trough idlers 210 are standing idlers. In these embodiments, these trough idlers 210 may be mountable to a second standing idler support structure.

One or more trough idler 210 of the second plurality of intermediate trough idlers 210 is mountable to a respective idler mounting portion 212 of the second plurality of intermediate trough idler mounting portions 212. One or more trough idler 210 of the second plurality of intermediate trough idlers 210 may be mounted to the respective idler mounting portion 212 of the second plurality of intermediate trough idler mounting portions 212 using a bolted joint.

When the conveyor belt redirection system 150 is constructed, each trough idler 210 of the second plurality of intermediate trough idlers 210 may be said to be supported at a respective second intermediate trough idler elevation 214 (shown in FIG. 11). In other words, the second intermediate trough idler mounting portions 212 are configured to enable the second intermediate trough idlers 210 to be mounted at respective second intermediate trough idler elevations 214. The second intermediate trough idler elevations 214 are greater than or equal to the end elevation 194 (shown in FIG. 13). The second intermediate trough idler elevations 214 are greater than or equal to the initial elevation 184. In some embodiments, one or more of the second intermediate trough idler elevations 214 may be less than one or both of the initial elevation 184 and the end elevation 194.

When the conveyor belt redirection system 150 is constructed, each trough idler mounting potion 212 of the second plurality of intermediate trough idler mounting portions 212 may be said to be positioned at a respective second intermediate trough idler mounting portion elevation 216 (shown in FIG. 11). The second intermediate trough idler mounting portion elevations 216 are greater than or equal to the initial elevation 184. The second intermediate trough idler mounting portion elevations 216 are greater than or equal to the end elevation 194. In some embodiments, one or more of the second intermediate trough idler mounting portion elevations 216 may be less than one or both of the initial elevation 184 and the end elevation 194.

In some embodiments, the second plurality of intermediate trough idler mounting portions 212 comprises a particular number of mounting portions 212. The particular number of mounting portions 212 may be a number greater than or equal to 1. In the illustrated embodiment, the second plurality of intermediate trough idler mounting portions 212 comprises 13 mounting portions 212. In some embodiments, the second plurality of intermediate trough idler mounting portions 212 comprises the same number of mounting portions 212 as the second plurality of intermediate trough idlers 210 comprises trough idlers 210. In some embodiments, the second plurality of intermediate trough idler mounting portions 212 comprises a different number of mounting portions 212 as the second plurality of intermediate trough idlers 210 comprises trough idlers 210. For example, in some embodiments, the second plurality of intermediate trough idler mounting portions 212 comprises a greater number of mounting portions 212 than the second plurality of intermediate trough idlers 210 comprises trough idlers 210.

Referring to FIG. 12, the second plurality of intermediate trough idler mounting portions 212 are positioned along a second longitudinal length 218 of the conveyor system 100. The second longitudinal length 218 extends parallel to the conveyor longitudinal axis 101. The second longitudinal length 218 is downstream of the first longitudinal length 200. The second longitudinal length 218 may be referred to as a second longitudinal length of the support structure 151. The second longitudinal length 218 may be referred to as a second longitudinal length of the conveyor belt redirection system 150. Therefore, when the second plurality of intermediate trough idlers 210 are mounted to the second plurality of intermediate trough idler mounting portions 212, the second plurality of intermediate trough idlers 210 may be said to be positioned along a second longitudinal length 218 of the conveyor belt redirection system 150.

The second longitudinal length 200 is between the downstream end 206 of the first longitudinal length 200 and the end trough idler 190. The second plurality of intermediate trough idler mounting portions 212 may therefore be said to be between an end of the first longitudinal length 200 and the end trough idler 190. Similarly, the second plurality of intermediate trough idlers 210 may be said to be positioned between the downstream end 206 of the first longitudinal length 200 and the end trough idler 190. In other words, the second plurality of intermediate trough idlers 210 may be said to be positioned between an end of the first longitudinal length 200 and the end trough idler 190.

When the conveyor belt redirection system 150 is constructed, the second plurality of intermediate trough idler mounting portions 212 are positioned at successively decreasing elevations as the second longitudinal length 218 is traversed from an upstream end 220 to a downstream end 222. In other words, the second intermediate trough idler mounting portion elevations 216 decrease along the second longitudinal length 218. The upstream end 220 of the second longitudinal length 218 may correspond to the downstream end 206 of the first longitudinal length 200. In some embodiments, the upstream end 220 of the second longitudinal length 218 is separated from the downstream end 206 of the first longitudinal length 200 by a separation distance.

The second plurality of intermediate trough idler mounting portions 212 is configured to enable the second plurality of intermediate trough idlers 210 to be supported at successively decreasing elevations along the second longitudinal length 200. When the conveyor belt redirection system 150 is constructed, the second plurality of intermediate trough idlers 210 are therefore supported at successively decreasing elevations along the second longitudinal length 218.

It will be appreciated that in some embodiments, one or more of the idler mounting portions 212 of the second plurality of intermediate trough idler mounting portions 212 may be positioned at a common elevation, relative to the reference plane 146, as an immediately preceding idler mounting portion 212. That is, while a trend in the elevation of the second plurality of intermediate trough idler mounting portions 212 along the second longitudinal length 218 may be a decrease in elevation, it will be understood that each idler mounting portion 212 of the second plurality of intermediate trough idler mounting portions 212 does not necessarily need to be at a lower elevation than the immediately preceding idler mounting portion 212.

It will also be appreciated that in some embodiments, one or more of the trough idlers 210 of the second plurality of intermediate trough idlers 210 may be positioned at a common elevation, relative to the reference plane 146, as an immediately preceding trough idler 210. That is, while a trend in the elevation of the second plurality of intermediate trough idlers 210 along the second longitudinal length 218 may be a decrease in elevation, it will be understood that each trough idler 210 of the second plurality of intermediate trough idlers 212 does not necessarily need to be at a lower elevation than the immediately preceding trough idler 210.

When the conveyor belt redirection system 150 is constructed, the second plurality of intermediate trough idler mounting portions 212 is downstream of the first plurality of intermediate trough idler mounting portions 198. In other words, the mounting portions 198 of the first plurality of intermediate trough idler mounting portions 198 are closer to the head pulley 112 than the mounting portions 198 of the first plurality of intermediate trough idler mounting portions 198. When the conveyor belt redirection system 150 is constructed, the second plurality of intermediate trough idlers 210 is downstream of the first plurality of intermediate trough idlers 196. In other words, the trough idlers 210 of the second plurality of intermediate trough idlers 210 are closer to the head pulley 112 than the trough idlers 196 of the first plurality of intermediate trough idlers 196.

When mounted to the second plurality of intermediate trough idler mounting portions 212, the second plurality of intermediate trough idlers 210 are spaced apart along the support structure 151. One or more of the second plurality of intermediate trough idlers 210 is separated from an adjacent intermediate trough idler 212 by a second spacing 191. The second spacing 191 is a distance. The second spacing 191 may be measured by connecting the relevant intermediate trough idlers 210 with a straight line. The second spacing 191 is associated with a spacing between the idler mounting portions 212. For example, in some embodiments, the relevant intermediate trough idler mounting portions 212 are separated by the second spacing 191. As a result, the corresponding intermediate trough idlers 210 may also be separated by a distance equal to the second spacing 191. The second spacing 191 may therefore be measured by connecting the relevant intermediate trough idler mounting portions 212 with a straight line.

In some embodiments, each of the second plurality of intermediate trough idler mounting portions 212 is separated from the adjacent intermediate trough idler mounting portion(s) 212 by the same distance. In some embodiments, each of the second plurality of intermediate trough idlers 210 is separated from the adjacent intermediate trough idler 210 by the same distance. In some embodiments, the second spacing 191 is equal to the first spacing 189. In some embodiments, the second spacing 191 is about 3 metres. In some embodiments, the second spacing 191 is 1 metre, 1.5 metres, 2 metres, 2.5 metres, 3 metres, 3.5 metres, 4 metres, 4.5 metres, 5 metres or more than 5 metres. In some embodiments, the second spacing 191 is between 1 and 10 metres or between 2 and 5 metres. In some embodiments, the second spacing 191 is proportional to a desired curvature of the conveyor belt 102.

### Second Concave Down Mounting Portion Path 242

Referring to FIGS. 13, 16 and 18, when the support structure 151 is constructed, the second plurality of intermediate trough idler mounting portions 212 and the end trough idler mounting portion 192 define a concave down curve. That is, the second plurality of intermediate trough idler mounting portions 212 and the end trough idler mounting portion 192 define a concave down mounting portion path 242. In particular, a curve connecting the respective reference point of each mounting portion 212, 192 defines the concave down mounting portion path 242. The concave down mounting portion path 242 has a concave down profile. The concave down mounting portion path 242 has a continuous gradient. The concave down mounting portion path 242 may be referred to as a second concave down mounting portion path 242.

The gradient of the second concave down mounting portion path 242 decreases along its length in the conveyor system longitudinal direction 109. In other words, the gradient of the second concave down mounting portion path 242 decreases when traversing the second concave down mounting portion path 242 away from the initial trough idler mounting portion 182, in the conveyor system longitudinal direction 109. The second concave down mounting portion path 242 has a third radius of curvature 244. The third radius of curvature 244 is equal to or greater than the threshold radius. In some embodiments, the third radius of curvature 244 is equal to the second radius of curvature 234. In some embodiments, the third radius of curvature 244 is equal to the first radius of curvature 228.

The second concave down mounting portion path 242 extends from a second peak mounting portion elevation 246 to a descended mounting portion elevation 248. The descended mounting portion elevation 248 is less than the second peak mounting portion elevation 246. The descended mounting portion elevation 248 is equal to the end trough idler mounting portion elevation 185. In some embodiments, the descended mounting portion elevation 248 is greater than the initial elevation 184. In some embodiments, the descended mounting portion elevation 248 is equal to the initial elevation 184. In some embodiments, the descended mounting portion elevation 248 is less than the initial elevation 184. In some embodiments, the first peak mounting portion elevation 238 is equal to the second peak mounting portion elevation 246. In some embodiments, the first peak mounting portion elevation 238 is greater than the second peak mounting portion elevation 246. This may be the case, for example, if there are one or more idlers 130 and/or idler mounting portions 182 in-between the second subset 230 of the first plurality of intermediate trough idler mounting portions 198 and the second plurality of intermediate trough idler mounting portions 212. In some embodiments, the first peak mounting portion elevation 238 is less than the second peak mounting portion elevation 246. In some embodiments, the first concave down mounting portion path 232 and the second concave down mounting portion path 242 are contiguous. In some embodiments, the first concave down mounting portion path 232 and the second concave down mounting portion path 242 are not contiguous. For example, there may be one or more idlers 130 and/or idler mounting portions 182 in-between the first concave down mounting portion path 232 and the second concave down mounting portion path 242.

### Second Concave Down Idler Path 264

When the support structure 151 is constructed, the second plurality of intermediate trough idlers 210 and the end idler 190 define a concave down curve. That is, the second plurality of intermediate trough idlers 210 and the end idler 190 define a concave down idler path 264. The concave down idler path 264 may be referred to as a second concave down idler path 264. A curve connecting the respective reference point of each trough idler 210 and the end idler 190 defines the second concave down idler path 264. The second concave down idler path 264 has a concave down profile. The second concave down idler path 264 has a continuous gradient. The conveyor belt 102 is moved through a curved path corresponding to the second concave down idler path 264 as it is driven across the second plurality of intermediate trough idlers 210 and the end idler 190.

The gradient of the second concave down idler path 264 decreases along its length in the conveyor system longitudinal direction 109. In other words, the gradient of the second concave down idler path 264 decreases when traversing the second concave down idler path 264 away from the initial trough idler 180, in the conveyor system longitudinal direction 109. The second concave down idler path 264 has a third radius of curvature 266. The third radius of curvature 266 is equal to or greater than a third threshold radius. The third threshold radius is a radius at which an edge tension of the conveyor belt 102, when supported by the idlers 130 and shaped to form the trough 119, is below a second edge tension threshold. In some embodiments, the third radius of curvature 266 is equal to one or both of the first radius of curvature 252 and the second radius of curvature 258.

As the third radius of curvature 266 is equal to or greater than the third threshold radius, the edge tensions in the conveyor belt 102 as it is directed through a concave path corresponding to the second concave down idler path 264 will remain equal to or below the edge tension threshold. With the edge tension threshold corresponding to a tension above which damage is caused to the conveyor belt 102, damage to the conveyor belt 102 can be reduced by directing it through this concave path.

The second concave down idler path 264 extends from a second peak elevation 268 to a descended elevation 270. The descended elevation 270 is the elevation of the end idler 190. The descended elevation 270 is therefore the same as the end elevation 194. The descended elevation 270 is less than the second peak elevation 268. In some embodiments, the descended elevation 270 is greater than the initial elevation 184. In some embodiments, the descended elevation 270 is equal to the initial elevation 184. In some embodiments, the descended elevation 270 is less than the initial elevation 184. In some embodiments, the peak elevation 262 is equal to the second peak elevation 268. In some embodiments, the first concave down path 256 and the second concave down idler path 264 are contiguous.

When the conveyor belt 102 is supported by the conveyor belt redirection system 150, the conveyor belt 102 forms a first concave up portion 177. The first concave up portion 177 is supported at least in part by some of the first plurality of intermediate trough idlers 196. The conveyor belt 102 also forms a concave down portion 179. The first concave down portion 179 is supported by a number of the first plurality of intermediate trough idlers 196 and a number of the second plurality of intermediate trough idlers 210.

### Plurality of Shuttle Idlers 138

When the conveyor belt system 100 is constructed, each shuttle idler 138 may be said to be supported at a respective shuttle idler elevation 272 (shown in FIGS. 11 and 13). In other words, the shuttle idler mounting portions 137 are configured to enable the shuttle idlers 138 to be mounted at respective shuttle idler elevations 272. The shuttle elevations 272 are less than the initial elevation 184 (shown in FIG. 11). The shuttle elevations 272 are less than the end elevation 194 (shown in FIG. 13).

When the conveyor belt redirection system 150 is constructed, each shuttle idler mounting potion 137 may be said to be positioned at a respective shuttle idler mounting portion elevation 274 (shown in FIGS. 11 and 13). The shuttle idler mounting portion elevations 274 are lower than the initial trough idler mounting portion elevation 183 (shown in FIG. 11). The shuttle idler mounting portion elevations 274 are less than the end trough idler mounting portion elevation 185 (shown in FIG. 13).

When the conveyor system 100 is constructed, the shuttle idler mounting portions 137 are lower than the second plurality of intermediate trough idler mounting portions 212. Some of the shuttle idler mounting portions 137 are downstream of the second plurality of intermediate trough idler mounting portions 212. The shuttle 126 is operable such that when the shuttle 126 is in the retracted position 142, a number of the shuttle idler mounting portions 137 are positioned below the second plurality of intermediate trough idler mounting portions 212. When the conveyor system 100 is constructed, the shuttle idlers 138 are lower than the second plurality of intermediate trough idlers 210. Some of the shuttle idlers 138 are downstream of the second plurality of intermediate trough idlers 210. The shuttle 126 is operable such that when the shuttle 126 is in the retracted position 142, a number of the shuttle idlers 138 are positioned below the trough idlers 212 of the second plurality of intermediate trough idlers 210.

As described herein, the conveyor system 100 comprises the transition portion 145. The transition portion 145 is a result of the shuttle idlers 138 being disposed at elevations below the elevation of the end trough idler 190. However, due to the initially ascending and subsequently descending conveyor belt circuit upstream of the transition portion 145, the vertical radii through which the conveyor belt 102 is passed can be larger than those of conveyor systems that do not include the described conveyor belt redirection system 150.

As the conveyor belt 102 is directed across the second plurality of intermediate trough idlers 210, the end idler 190 and one or more of the shuttle idlers 138, it is directed through a downward change in elevation. At least part of the downward change in elevation corresponds to the descending idler path of the second plurality of intermediate trough idlers 210 that support the conveyor belt 102.

A number of the second plurality of intermediate trough idlers 210 and the end trough idler 190 support the conveyor belt 102 through one or more vertical curves 178. In particular, the conveyor belt 102 is supported through a second concave down vertical curve 178″. By doing so, the intermediate trough idlers 210 direct the conveyor belt 102 through part of the downward change in elevation. The conveyor system 100 may therefore be said to direct the conveyor belt 102 through the second concave down vertical curve 178″′ at the downward change in elevation.

The second concave down vertical curve 178″′ spans at least part of the downward change in elevation of the conveyor belt 102. The conveyor belt 102 is supported in the second concave down vertical curve 178″′ by the second subset 230 of the second plurality of intermediate trough idlers 210.

The second concave down vertical curve has an associated radius of curvature. The radius of curvature of the second concave down vertical curvature is equal to or greater than the threshold radius described with reference to the first concave up vertical curve 178′.

### Third Plurality of Intermediate Trough Idlers

The first plurality of intermediate trough idlers 196 and the second plurality of intermediate trough idlers 210 shown in FIGS. 3 to 18 form a contiguous idler path, as described herein. It will be appreciated that in some embodiments, the conveyor belt redirection system 150 may comprise a third plurality of intermediate trough idlers (not shown). The third plurality of intermediate trough idlers may be supported by the support structure 151. The third plurality of intermediate trough idlers may be supported along an intermediate longitudinal length of the conveyor belt redirection system that is between the end of the first longitudinal length 200 and an end of the second longitudinal length 218. The relevant end of the second longitudinal length 218 may be considered to be the start of the second longitudinal length 218. Therefore, the third plurality of intermediate trough idlers may be said to be supported and/or disposed between the first plurality of intermediate trough idlers 196 and the second plurality of intermediate trough idlers 210.

The third plurality of intermediate trough idlers may form one or more of an ascending idler path and a descending idler path. That is, one or more trough idlers of the third plurality of intermediate trough idlers may be supported, by the support structure, at a higher elevation, relative to the reference plane 186, than a preceding trough idler of the third plurality of intermediate trough idlers. One or more trough idlers of the third plurality of intermediate trough idlers may be supported, by the support structure, at a common elevation, relative to the reference plane 186, than a preceding trough idler of the third plurality of intermediate trough idlers. One or more trough idlers of the third plurality of intermediate trough idlers may be supported, by the support structure, at a higher election, relative to the reference plane 186, than a preceding trough idler of the third plurality of intermediate trough idlers. It may therefore be said that the support structure 151 is configured to support one or more of the third plurality of intermediate trough idlers as described herein. Each of the trough idlers of the third plurality of intermediate trough idlers may be supported by a respective trough idler mounting portion of the support structure 151.

### The Conveyor Belt Redirection System may be Retrofittable

It will be appreciated that the conveyor belt redirection system 150 may be retrofitted onto an already-installed conveyor that is suffering from accelerated belt wearing. For example, where an existing shuttle conveyor suffers from accelerated belt wearing due, at least in part, to a change in elevation of the relevant conveyor belt, the described conveyor belt redirection system 150 can be installed to reduce the rate at which the belt wears. It will therefore be appreciated that the conveyor belt redirection system 150 may be manufactured and distributed as a module. It will also be understood that the conveyor belt redirection system 150 may be distributed without the trough idlers 158, as a user may wish to install trough idlers according to their own requirements and/or specification.

### Conveyor Belt Redirection System Facilitating an Increase in Elevation

The conveyor belt redirection system 150 has been described herein in the context of facilitating a decrease in elevation. That is, in the conveyor system 100 of FIGS. 2 to 18, the elevation of the conveyor belt 102, with respect to the reference plane 186, upstream of the transition portion 145, is greater than the elevation of the conveyor belt 102, with respect to the reference plane 186, downstream of the transition portion 145.

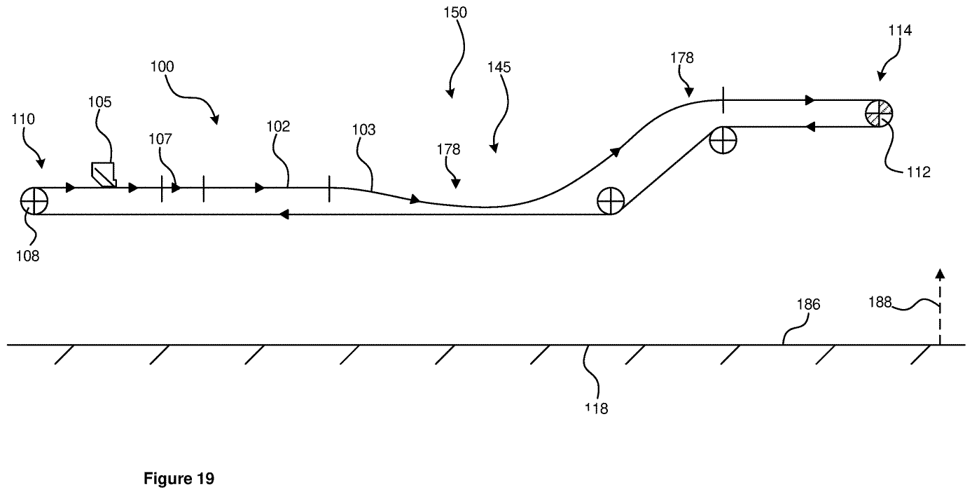

As shown in FIG. 19, in some embodiments, a similar conveyor belt redirection system 150 facilitates an increase in elevation of a conveyor system 100.

That is, in some embodiments, the elevation of the conveyor belt 102, with respect to the reference plane 186, upstream of the transition portion 145 is lower than the elevation of the conveyor belt 102, downstream of the transition portion 145.

In an embodiment, the transition portion 145 comprises a downward change in elevation and a subsequent upward change in elevation, with the upward change in elevation being greater than the downward change in elevation. As described herein with reference to FIGS. 2 to 18, the conveyor belt 102 of the embodiment of FIG. 19 is also directed through a number of vertical curves 178 at the transition portion 145. The conveyor belt redirection system 150 of FIG. 19 may be constructed such that the vertical curves 178 through which the conveyor belt 102 is directed are greater than a threshold radius that ensures the edge tension is less than or equal to an edge tension threshold of the conveyor belt 102 as it transits the transition portion 145 to the higher plane of elevation.

It will be understood that features of the conveyor system 100 of FIG. 19 that are similar to, or the same as, features described with reference to conveyor system 100 of FIGS. 2 to 18 are labelled in FIG. 19 using the same reference numerals as the corresponding features of FIGS. 2 to 18.

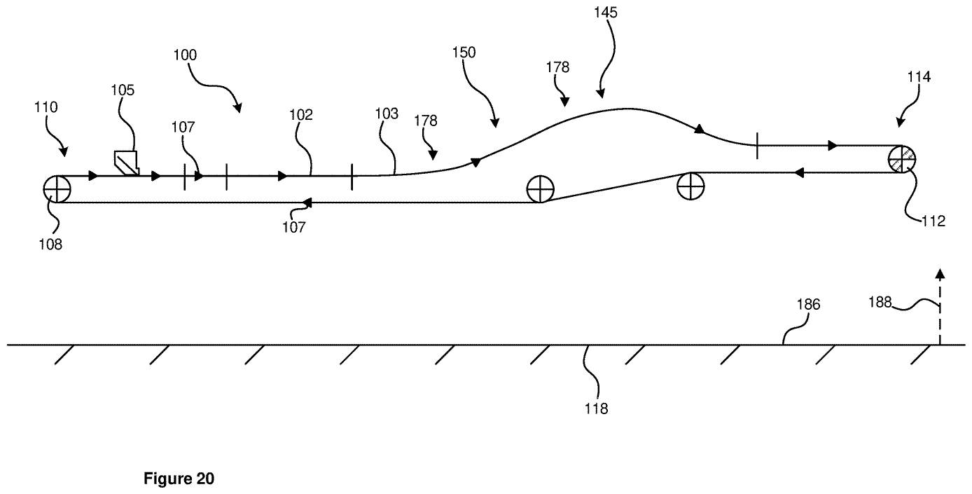

FIG. 20 shows a schematic of another alternative conveyor system 100. The conveyor system 100 of FIG. 20 comprises a conveyor belt redirection system 150 that facilitates an increase in elevation.

That is, the elevation of the conveyor belt 102, with respect to the reference plane 186, upstream of the transition portion 145, is lower than the elevation of the conveyor belt 102, with respect to the reference plane 186, downstream of the transition portion 145.

In the conveyor system 100 of FIG. 20, the transition portion 145 comprises an upward change in elevation and a subsequent downward change in elevation. The upward change in elevation is greater than the downward change in elevation. As described herein with reference to FIGS. 2 to 18, the conveyor belt 102 of the embodiment of FIG. 20 is also directed through a number of vertical curves 178 at the transition portion 145.

The conveyor belt redirection system 150 of FIG. 20 may be constructed such that the vertical curves 178 through which the conveyor belt 102 is directed are greater than a threshold radius that ensures the edge tension is less than or equal to an edge tension threshold of the conveyor belt 102 as it transits the transition portion 145 to the higher plane of elevation.

It will be understood that features of the conveyor system 100 of FIG. 20 that are similar to, or the same as, features described with reference to conveyor system 100 of FIGS. 2 to 18 are labelled in FIG. 20 using the same reference numerals as the corresponding features of FIGS. 2 to 18.

Embodiments of the conveyor belt redirection system 150 that facilitate an increase in elevation may be useful, for example, in negotiating sudden upward changes in an underlying landscape. Therefore, it will also be understood that embodiments of the disclosure are not limited to shuttle conveyors. That is, embodiments of the disclosure may be used in conveyor systems that do not include shuttles.

### Conveyor Belt Redirection System Facilitating Undulating Landscapes

As described herein, conveyor systems can be subject to various constraints that influence the profile of the conveyor systems and/or the conveyor belt circuits of the relevant conveyor systems. One such constraint may be where a conveyor system is required to convey a material over landscape that includes a change in elevation (e.g. a crest of a hill). A conveyor belt redirection system 150 like that described herein can be used to ensure the radius of the vertical curves 178 through which a conveyor belt 102 is directed as it transits the change landscape elevation remain above the threshold radius, thereby reducing the edge tension of the conveyor belt 102.

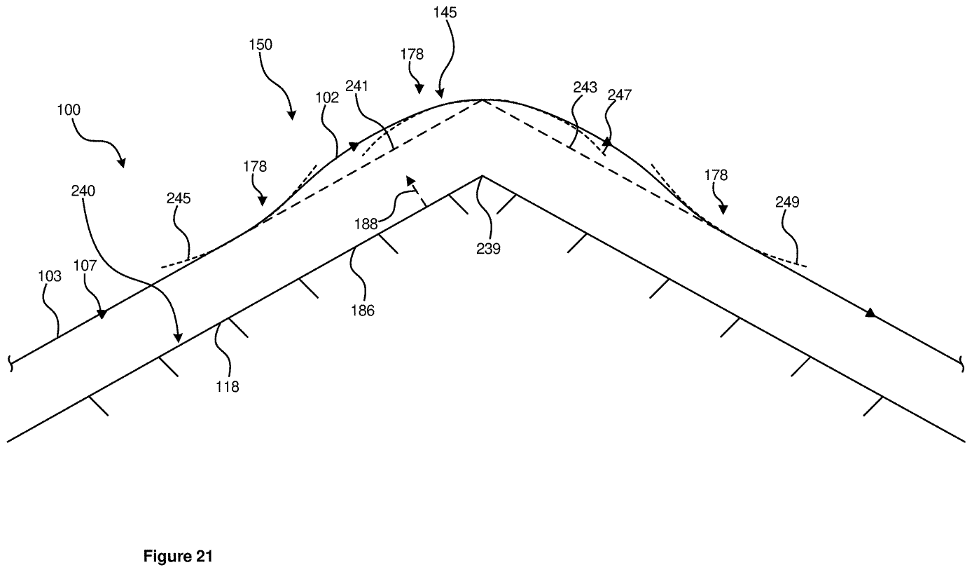

FIG. 21 shows a schematic of part of such a conveyor system 100.

It will be understood that features of the conveyor system 100 of FIG. 21 that are similar to, or the same as, features described with reference to conveyor system 100 of FIGS. 2 to 18 are labelled in FIG. 21 using the same reference numerals as the corresponding features of FIGS. 2 to 18.

For simplicity, the structural features of the conveyor belt redirection system 150 are hidden in FIG. 21; however, the profile of the conveyor belt 102 as supported by the conveyor belt redirection system 150 is shown.

The conveyor system 100 of FIG. 21 traverses a hill 240. As indicated by dashed lines 241 and 243, if the conveyor belt 102 was directed along a linear path to a crest 239 of the hill 240, and a subsequent linear path after transiting the crest 239, the conveyor belt 102 would be directed through a sharp angle that may result in the conveyor belt 102 transiting a radius of curvature at the crest that is smaller than a recommended operating radius of the conveyor belt 102 (i.e. the threshold radius). As described herein, such a conveyor belt 102 may therefore be subject to out of specification edge tensions and/or accelerated wear.

The conveyor system 100 of FIG. 21 includes a conveyor belt redirection system 150 to assist with increasing the radii of the vertical curves 178 through which the conveyor belt 102 is directed as it transits the hill 240. The conveyor belt redirection system 150 directs the conveyor belt 102 through an initial increase in elevation and a subsequent decrease in elevation. This increase in elevation and decrease in elevation may be considered relative to the reference plane 186, which may be parallel to an upstream surface of the hill 240, above which the conveyor belt 102 is directed.

In other words, the conveyor belt redirection system 150 directs the conveyor belt through a concave up vertical curve 245 and a subsequent concave down vertical curve 247, prior to the crest 239. The conveyor belt redirection system 150 directs the conveyor belt 102 through another concave up vertical curve 249 prior to the conveyor belt 102 being directed along a linear belt path on the other side of the crest 239.

The conveyor belt redirection system 150 described herein therefore enables the radii of curvature through which a conveyor belt 102 is directed, while transiting an undulating landscape, to be increased to mitigate the effects of the undulating landscape on the longevity of the conveyor belt 102.

### Advantages

The described conveyor system 100, at least by way of the provision of the described conveyor belt redirection system 150 enables a reduction of the edge tensions in the conveyor belt 102 during operation. The first plurality of intermediate trough idlers 196 are positioned such that the conveyor belt 102 is directed through an ascending path. Subsequently, the conveyor belt 102 is directed through a descending path prior to transferring to the shuttle 126 at the transition portion 145. By redirecting the conveyor belt 102 to first ascend and then descend prior to the conveyor belt 102 transferring to the shuttle 126, the radius of one or more of the vertical curves 178 through which the conveyor belt 102 passes can be increased relative to a conveyor system that directs a conveyor belt from one horizontal linear belt path directly to another horizontal linear belt path that is at a lower elevation without the redirection described herein.

The conveyor belt redirection system 150 therefore enables the radii of the vertical curves 178 through which the conveyor belt 102 passes to be increased to or above a minimum recommended operating radius. By increasing the radii through which the conveyor belt 102 passes using the described conveyor belt redirection system 150, the edge tension of the conveyor belt 102 at and around the transition portion 145 can be reduced compared to other conveyor systems.

In some embodiments, the edge tension of the conveyor belt 102 can be reduced by a factor of 4 or more by increasing the radii through which the conveyor belt 102 passes using the described conveyor belt redirection system 150. The significant reduction in the edge tension can result in the edge tension being brought underneath the recommended edge tension threshold.

The lifespan of the conveyor belt 102 may be increased as a result of increasing the radii of the vertical curves 178 through which the conveyor belt 102 passes toward or above the minimum recommended operating radius and/or reducing the edge tension of the conveyor belt toward or below the recommended edge tension threshold. Therefore, the described conveyor system 100 enables a significant reduction in the frequency with which the conveyor belt 102 needs to be replaced. This can result in an improvement in the production capacity and/or operating efficiency of the production facility that uses the conveyor system 100.

Further, reducing the edge tension of the conveyor belt 102 can enable the use of a cheaper conveyor belt. For example, a conveyor belt with a smaller belt thickness or a reduced mass may be suitable for use with the conveyor system 100, relative to other conveyor systems, without a significant increase in the frequency with which the thinner or lighter conveyor belt needs to be repaired or replaced.

As described herein, conveyor systems can be subject to various constraints that influence the profile of the conveyor system and/or the conveyor belt circuit of the relevant conveyor system. Such conveyor systems may be required to include a change in elevation in a path through which a conveyor belt that is shaped into a trough is moved. For example, in the case of shuttle conveyors, it is often difficult or impossible to reduce the radii through which a conveyor belt is directed as it transits from a linear belt path, through the transition portion and onto the shuttle, because of the necessary movement of the shuttle underneath the idlers supporting the conveyor belt before it moves onto the shuttle. Specifically, reducing the elevation of the idlers immediately prior to the shuttle to increase the radius of curvature through which the conveyor belt is directed is not an option. This is because the clearance between these idlers and the shuttle idlers must be able to accommodate the withdrawal of the shuttle from the extended position to the retracted position, without these idlers impacting the shuttle idlers. The conveyor belt redirection system 150 of the present disclosure enables the radii of the vertical curves 178 through which the conveyor belt 102 is directed to be increased within the otherwise fixed constraints that are a result of the functionality of the shuttle 126. Similar benefits can be realised where the conveyor belt redirection system 150 is implemented on other conveyor systems that do not necessarily include a shuttle, but that do include changes in elevation within constrained spaces and/or geometries.

The conveyor system 100 may also be operable using less energy than conveyor systems that do not include the described conveyor belt redirection system 150. That is, reducing the edge tension of the conveyor belt 102 in the region of the transition portion 145 can provide a reduction in the energy required to move the conveyor belt 102 through the conveyor belt circuit 103. For example, by way of enabling the use of a conveyor belt with a reduced mass, the energy requirements of the conveyor system 100 can be reduced as less energy is required to move a lighter conveyor belt.

Many modifications may be made to the embodiments described herein without departing from the spirit and scope of the disclosure. For example, although the conveyor belt redirection system 150 is described with reference to a conveyor system comprising a shuttle 126, it will also be appreciated that redirecting a conveyor belt as described may also be applicable to, and provide comparable advantages to, other types of conveyors that operate at multiple elevations.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

1. A conveyor system supporting a conveyor belt in a trough shape through a transition portion where the conveyor belt drops from a linear belt path at one elevation to another linear belt path at a lower elevation, the transition portion comprising an upward change in elevation and a subsequent downward change in elevation, whereby a radius of one or more vertical curves through which the conveyor belt is directed for the change in elevation is larger than through that which it would have been directed without the upward change in elevation.

2. The conveyor system of claim 1, wherein the downward change in elevation is greater than the upward change in elevation.

3. The conveyor system of claim wherein the conveyor belt is directed through a number of vertical curves at the transition portion.

4. The conveyor system of claim 3, wherein a radius of curvature of one or more of the vertical curves is greater than a threshold radius.

5. The conveyor system of claim wherein the conveyor belt is directed through a first concave up vertical curve and a first concave down vertical curve at the upward change in elevation.

6. The conveyor system of claim 5, wherein the conveyor belt is directed through a second concave down vertical curve at the downward change in elevation.

7. The conveyor system ofany claims 1to 6, comprising:
a plurality of trough idlers; and
a support structure onto which the plurality of trough idlers are mounted;
wherein the trough idlers are configured to support the conveyor belt in the trough shape.

8. The conveyor system of claim 7, wherein the plurality of trough idlers comprises a first plurality of intermediate trough idlers comprising:
a first subset of trough idlers that form a first concave up idler path; and
a second subset of trough idlers that form a first concave down idler path.

9. The conveyor system of claim 8, wherein the first concave up idler path defines a first radius of curvature that is greater than a first threshold radius.

10. The conveyor system of claim 9, wherein the first concave down idler path defines a second radius of curvature that is greater than a second threshold radius.

11. The conveyor system of claim 8, wherein the first concave up idler path and the first concave down idler path form an ascending idler path that is contiguous.

12. The conveyor system of claim 11, wherein the plurality of trough idlers comprises:
a second plurality of intermediate trough idlers; and
an end trough idler;
wherein the second plurality of intermediate trough idlers and the end trough idler form a second concave down idler path.

13. The conveyor system of claim 12, wherein a radius of curvature of the second concave down idler path is greater than a third threshold radius.

14. The conveyor system of claim 12, wherein the ascending idler path and the second concave down idler path are contiguous.

15. The conveyor system of claim 12, wherein:
the support structure comprises:
a standing idler support structure; and
a hanging idler support structure; and
the first plurality of intermediate trough idlers comprises a number of standing idlers that are mounted to the standing idler support structure; and
the second plurality of intermediate trough idlers comprises a number of hanging idlers that are mounted to the hanging idler support structure.

16. The conveyor system of claim 12, comprising a shuttle that comprises:
a plurality of shuttle idlers configured to support the conveyor belt; and
a head pulley;
wherein:
the shuttle is configured to be moved between:
an extended position; and
a retracted position in which one or more of the shuttle idlers are retracted underneath the transition portion.

17. The conveyor system of claim 16, further comprising a shuttle drive system that is operably connected to the shuttle, the shuttle drive system being operable to move the shuttle between the extended position and the retracted position.

18. The conveyor system of claim 16, wherein movement of the shuttle from the extended position to the retracted position causes at least one of the plurality of shuttle trough idlers to pass below one of the second plurality of intermediate trough idlers.

19. (canceled)

20. A conveyor belt redirection system to change elevation of a linear belt path from a liner belt path at an initial elevation to a linear belt path at an end elevation lower than the initial elevation, the conveyor belt redirection system comprising:
a plurality of trough idlers configured to support a conveyor belt, the plurality of trough idlers comprising:
an initial trough idler;
a first plurality of intermediate trough idlers;
a second plurality of intermediate trough idlers; and
an end trough idler; and
a support structure configured to support:
the initial trough idler at an initial elevation, relative to a reference plane;
the end trough idler at an end elevation, relative to the reference plane;
the first plurality of intermediate trough idlers along a first longitudinal length of the conveyor belt redirection system at successively increasing elevations, relative to the reference plane, that are greater than the initial elevation; and
the second plurality of intermediate trough idlers along a second longitudinal length of the conveyor belt redirection system that is between an end of the first longitudinal length and the end trough idler, at successively decreasing elevations, relative to the reference plane, that are greater than the end elevation, whereby a radius of one or more vertical curves through which a conveyor belt supported by the plurality of trough idlers is directed for the change in elevation is larger than through that which it would have been directed without the upward change in elevation.

21.-41. (canceled)

42. A conveyor belt system support structure to change elevation of a linear belt path from a liner belt path at an initial elevation to a linear belt path at an end elevation lower than the initial elevation, the support structure comprising:
an initial trough idler mounting portion configured to enable an initial trough idler to be mounted at an initial elevation, relative to a reference plane;
an end trough idler mounting portion configured to enable an end trough idler to be mounted at an end elevation, relative to the reference plane;
a first plurality of intermediate trough idler mounting portions positioned along a first longitudinal length of the support structure, the first plurality of intermediate trough idler mounting portions being configured to enable a first plurality of intermediate trough idlers to be positioned at successively increasing elevations, relative to the reference plane, that are greater than the initial elevation; and
a second plurality of intermediate trough idler mounting portions positioned along a second longitudinal length of the support structure, the second plurality of intermediate trough idler mounting portions being configured to enable a second plurality of intermediate trough idlers to be positioned along the second longitudinal length of the support structure, between an end of the first longitudinal length and the end trough idler, at successively decreasing elevations, relative to the reference plane, that are greater than the end elevation, whereby a radius of one or more vertical curves through which a conveyor belt supported by trough idlers on the support structure is directed for the change in elevation is larger than through that which it would have been directed without the upward change in elevation.

43.-63. (canceled)
